(19) United States
(12) Patent Application Publication
(10) Pub. No.: US 2006/0183102 A1
(43) Pub. Date: Aug. 17, 2006

(54) Serum-free reagents for the isolation, cultivation, and cryopreservation of postnatal pluripotent epiblast-like stem cells

(76) Inventors: Henry E. Young, Macon, GA (US); Calvin Asa Black JR., Macon, GA (US)

Correspondence Address: WITHERS & KEYS, LLC, P. O. BOX 2049, MCDONOUGH, GA, 30253, US

(21) Appl. No.: 11/353,909

(22) Filed: Feb. 13, 2006

Related U.S. Application Data
(60) Provisional application No. 60/652,697, filed on Feb. 14, 2005.

(51) Int. Cl. A01N 1/02

(52) U.S. Cl. 435/1.1

(57) ABSTRACT

Serum-free solutions suitable for use with postnatal pluripotent epiblast-like stem cells are disclosed. Methods of using serum-free solutions are also disclosed.

### CROSS-REFERENCE TO RELATED APPLICATIONS

This patent application claims the benefit of priority to U.S. provisional patent application Ser. No. 60/652,697 entitled “SERUM-FREE REAGENTS FOR THE ISOLATION, CULTIVATION, AND CRYOPRESERVATION OF POSTNATAL PLURIPOTENT EPIBLAST-LIKE STEM CELLS”, filed on Feb. 14, 2005, the subject matter of which is hereby incorporated by reference in its entirety.

### FIELD OF THE INVENTION

The present invention relates generally to serum-free reagents suitable for the isolation, cultivation, and cryopreservation of lineage-uncommitted postnatal pluripotent epiblast-like stem cells (PPELSC). The present invention further relates to methods for making and using the serum-free reagents and stem cells associated therewith.

### BACKGROUND OF THE INVENTION

The growth medium for cells grown in culture is routinely supplemented with animal and/or human serum to optimize and enhance cell viability. The constituents of serum include water, amino acids, minerals, vitamins, fatty acids, triglycerides, monosaccharides, disaccharides, polysaccharides, proteins, glycoproteins, glycolipids, proteoglycans, glycosaminoglycans, etc. Either singly or in combination, these serum constituents act as bioactive agents by impacting on the functional capabilities of the cells grown in culture. Potential bioactive agents present in serum include agents that induce proliferation, agents that induce differentiation, agents that accelerate phenotypic expression, agents that inhibit proliferation, agents that inhibit differentiation, and/or agents that inhibit phenotypic expression. Unfortunately, the identity(ies), concentration(s), and potential combinations of specific bioactive agents contained in different lots of animal or human serum is/are unknown. One or more of these unknown agents in serum have shown to have a negative impact on the isolation, cultivation, and cryopreservation of lineage-uncommitted postnatal pluripotent epiblast-like stem cells.

To circumvent the problems inherent with the use of animal and/or human serum in culture medium, serum-free solutions have been devised for the isolation, cultivation, and cryopreservation, of lineage-uncommitted postnatal pluripotent epiblast-like stem cells.

### SUMMARY OF THE INVENTION

The present invention is directed to a series of serum-free solutions suitable for use with postnatal pluripotent epiblast-like stem cells. The serum-free solutions may be used in the isolation, cultivation, and cryopreservation of lineage-uncommitted postnatal pluripotent epiblast-like stem cells.

According to one exemplary embodiment of the present invention, a serum-free defined solution to wash tissues prior to the tissue harvest of postnatal pluripotent epiblast-like stem cells comprises (a) a filter sterilized buffer solution comprising (i) Dulbecco's phosphate buffered saline containing calcium chloride and magnesium chloride, (ii) albumin, (iii) 2-mercaptoethanol, (iv) putrescine, (v) an antibiotic-antimycotic solution; and (vi) an optional amount of sterile sodium hydroxide or sterile hydrochloric acid to provide a serum-free solution having a pH of 7.4.

In a further exemplary embodiment of the present invention, a serum-free defined tissue harvest and storage medium for postnatal pluripotent epiblast-like stem cells comprises (a) a cell culture solution (i.e., Eagle's Minimal Essential Medium) buffered with HEPES and sodium bicarbonate, and supplemented with hypoxanthine, thymidine, sodium pyruvate, trace elements and growth factors (i.e., OPTI-MEM I); (b) an optional antibiotic-antimycotic solution; (c) putrescine; (d) 2-mercaptoethanol solution; (e) albumin; (f) collagen, and (g) an optional amount of sterile sodium hydroxide or sterile hydrochloric acid to provide a serum-free solution having a pH of 7.4.

In yet a further exemplary embodiment of the present invention, a serum-free defined cell medium for the isolation of postnatal pluripotent epiblast-like stem cells from body tissues comprises (a) a cell culture solution (i.e., Eagle's Minimal Essential Medium) buffered with HEPES and sodium bicarbonate, and supplemented with hypoxanthine, thymidine, sodium pyruvate, trace elements and growth factors (i.e., OPTI-MEM I); (b) an optional antibiotic-antimycotic solution; (c) putrescine; (d) 2-mercaptoethanol solution; (e) albumin; (f) dispase, (g) collagenase, and (h) an optional amount of sterile sodium hydroxide or sterile hydrochloric acid to provide a serum-free solution having a pH of 7.4.

In yet a further exemplary embodiment of the present invention, a serum-free defined plating medium for postnatal pluripotent epiblast-like stem cells comprises (a) a cell culture solution (i.e., Eagle's Minimal Essential Medium) buffered with HEPES and sodium bicarbonate, and supplemented with hypoxanthine, thymidine, sodium pyruvate, trace elements and growth factors (i.e., OPTI-MEM I); (b) an optional antibiotic-antimycotic solution; (c) putrescine; (d) 2-mercaptoethanol solution; (e) albumin; (f) collagen, (g) fibronectin, (h) platelet-derived growth factor-BB, and (i) an optional amount of sterile sodium hydroxide or sterile hydrochloric acid to provide a serum-free solution having a pH of 7.4.

In a further exemplary embodiment of the present invention, a serum-free defined cell wash solution for cultured postnatal pluripotent epiblast-like stem cells comprises (a) a cell culture solution (i.e., Eagle's Minimal Essential Medium) buffered with HEPES and sodium bicarbonate, and supplemented with hypoxanthine, thymidine, sodium pyruvate, GLUTAMAX, trace elements and growth factors (i.e., OPTI-MEM I with GLUTAMAX); (b) an optional antibiotic-antimycotic solution; (c) putrescine; (d) 2-mercaptoethanol solution; (e) albumin; and (f) an optional amount of sterile sodium hydroxide or sterile hydrochloric acid to provide a serum-free solution having a pH of 7.4.

In yet a further exemplary embodiment of the present invention, a serum-free defined propagation medium for postnatal pluripotent epiblast-like stem cells comprises (a) a cell culture solution (i.e., Eagle's Minimal Essential Medium) buffered with HEPES and sodium bicarbonate, and supplemented with hypoxanthine, thymidine, sodium pyruvate, trace elements and growth factors (i.e., OPTI-MEM I); (b) an optional antibiotic-antimycotic solution; (c) putrescine; (d) 2-mercaptoethanol solution; (e) albumin; (f) collagen, (g) fibronectin, (h) platelet-derived growth factor-BB, and (i) an optional amount of sterile sodium hydroxide or sterile hydrochloric acid to provide a serum-free solution having a pH of 7.4.

In yet a further exemplary embodiment of the present invention, a serum-free defined release solution-A for releasing postnatal pluripotent epiblast-like stem cells from culture surfaces comprises (a) a cell culture solution (i.e., Eagle's Minimal Essential Medium) containing L-glutamine and buffered with HEPES and sodium bicarbonate, and supplemented with hypoxanthine, thymidine, sodium pyruvate, trace elements and growth factors (i.e., OPTI-MEM I with GLUTAMAX); (b) an optional antibiotic-antimycotic solution; (c) putrescine; (d) 2-mercaptoethanol solution; (e) albumin; and (f) an optional amount of sterile sodium hydroxide or sterile hydrochloric acid to provide a serum-free solution having a pH of 7.4.

In yet a further exemplary embodiment of the present invention, a serum-free defined release solution-B for releasing postnatal pluripotent epiblast-like stem cells from culture surfaces comprises (a) Dulbecco's phosphate buffered saline optionally containing calcium chloride and magnesium chloride; (b) an optional antibiotic-antimycotic solution; (c) a putrescine-containing solution; (d) 2-mercaptoethanol solution; and (e) an optional amount of sterile sodium hydroxide or sterile hydrochloric acid to provide a serum-free solution having a pH of 7.4.

In yet a further exemplary embodiment of the present invention, a serum-free defined release solution-C for releasing postnatal pluripotent epiblast-like stem cells from culture surfaces comprises (a) Dulbecco's phosphate buffered saline without calcium chloride and without magnesium chloride; (b) an optional antibiotic-antimycotic solution; (c) a putrescine-containing solution; (d) 2-mercaptoethanol solution; (e) an EDTA solution; and (f) an optional amount of sterile sodium hydroxide or sterile hydrochloric acid to provide a serum-free solution having a pH of 7.4.

In yet a further exemplary embodiment of the present invention, a serum-free defined release solution-D for releasing postnatal pluripotent epiblast-like stem cells from culture surfaces comprises (a) Dulbecco's phosphate buffered saline without calcium chloride and without magnesium chloride; (b) an optional antibiotic-antimycotic solution; (c) a putrescine-containing solution; (d) 2-mercaptoethanol solution; (e) an EDTA solution; (f) trypsin, and (g) an optional amount of sterile sodium hydroxide or sterile hydrochloric acid to provide a serum-free solution having a pH of 7.4.

In yet a further exemplary embodiment of the present invention, a serum-free defined cryopreservation medium for postnatal pluripotent epiblast-like stem cells comprises (a) a cell culture solution (i.e., Eagle's Minimal Essential Medium) buffered with HEPES and sodium bicarbonate, and supplemented with hypoxanthine, thymidine, sodium pyruvate, trace elements and growth factors (i.e., OPTI-MEM I); (b) an optional antibiotic-antimycotic solution; (c) putrescine; (d) 2-mercaptoethanol solution; (e) albumin; (f) collagen, (g) fibronectin, (h) platelet-derived growth factor-BB, (i) dimethylsulfoxide and (j) an optional amount of sterile sodium hydroxide or sterile hydrochloric acid to provide a serum-free solution having a pH of 7.4.

These and other features and advantages of the present invention will become apparent after a review of the following detailed description of the disclosed embodiments and the appended claims.

### DETAILED DESCRIPTION OF THE INVENTION

The present invention is directed to serum-free solutions suitable for use with postnatal pluripotent epiblast-like stem cells. The serum-free solutions may be used in the isolation, cultivation, and cryopreservation of lineage-uncommitted postnatal pluripotent epiblast-like stem cells. The present invention is further directed to methods of using serum-free solutions in the isolation, cultivation, and cryopreservation of lineage-uncommitted postnatal pluripotent epiblast-like stem cells.

I. Serum-Free Solutions

The present invention is directed to a variety of serum-free solutions suitable for use with postnatal pluripotent epiblast-like stem cells. In one exemplary embodiment of the present invention, the serum-free solution comprises (a) a filter sterilized buffer solution comprising (i) (i) Dulbecco's phosphate buffered saline containing calcium chloride and magnesium chloride, (ii) albumin, (iii) 2-mercaptoethanol, (iv) putrescine, (v) an antibiotic-antimycotic solution (described below); and an optional amount of sterile sodium hydroxide or sterile hydrochloric acid to provide a serum-free solution having a pH of 7.4. This exemplary serum-free solution is particularly suitable for washing tissue prior to tissue harvest of postnatal pluripotent epiblast-like stem cells.

The exemplary serum-free solution contains Dulbecco's phosphate buffered saline containing calcium chloride and magnesium chloride. (also referred to herein as “a buffered saline solution”). The composition of Dulbecco's phosphate buffered saline containing calcium chloride and magnesium chloride is shown in Table 1 below.

TABLE 1
Dulbecco's Phosphate Buffered Saline Containing
Calcium Chloride and Magnesium Chloride

| Component | Grams Per Liter (g/L) |
|---|---|
| CaCl₂.2H₂O | 0.133 |
| MgCl₂.6H₂O | 0.1 |
| KCl | 0.2 |
| KH₂PO₄ (anhydride) | 0.2 |
| NaCl | 8.0 |
| Na₂HPO₄ (anhydride) | 1.15 |

The serum-free solution further comprises an antibiotic-antimycotic solution. Suitable antibiotic-antimycotic solutions comprise, but are not limited to, antibiotic-antimycotic solutions containing at least one of penicillin, streptomycin, and fungizone. Desirably, the 100X antibiotic-antimycotic solution comprises about 10,000 units/ml Penicillin G, about 10,000 μg/ml Streptomycin, and about 25 μg/ml Amphotericin B, more desirably, a preferred antibiotic-antimycotic solution comprises 10,000 units/ml Penicillin G, 10,000 μg/ml Streptomycin, and 25 μg/ml Amphotericin B (hereinafter referred to as “the preferred antibiotic-antimycotic solution”). Such antibiotic-antimycotic solutions are commercially available from Mediatech, Inc. (Herndon, Va.) under the trade designation CELLGRO® and commercially available from Invitrogen Corporation (Carlsbad, Calif.) under the trade designation GIBCO®.

Other suitable antibiotic-antimycotic solutions include, but are not limited to, solutions containing about 10,000 units/ml Penicillin G and/or about 10,000 μg/ml Streptomycin and/or about 25 μg/ml Amphotericin B; or any other type of antibiotic and/or antimycotic solution capable of preventing microbiological contamination of the cultured cells. Such other suitable antibiotic-antimycotic solutions are also commercially available from Mediatech, Inc. (Herndon, Va.) and Invitrogen Corporation (Carlsbad, Calif.).

The putrescine-containing solution may comprise a filter sterilized solution containing putrescine and one or more additional components. In one exemplary embodiment, the putrescine-containing solution comprises a filter sterilized solution containing putrescine, cell culture media, and an optional amount of sterile sodium hydroxide or sterile hydrochloric acid to provide a putrescine-containing solution having a pH of 7.4. The cell culture media desirably comprises OPTI-MEM I with GLUTAMAX commercially available from Gibco/Invitrogen Corporation (Carlsbad, Calif.). OPTI-MEM I with GLUTAMAX comprises a modification of Eagle's Minimal Essential Medium buffered with HEPES and sodium bicarbonate, and supplemented with hypoxanthine, thymidine, sodium pyruvate, GLUTAMAX, trace elements and growth factors (hereinafter referred to as “the second preferred cell culture solution”).

The above-described serum-free solution desirably comprises (a) greater than about 90 percent by weight of the filter sterilized buffer solution, wherein the filter sterilized buffer solution comprises (i) greater than about 90 percent by weight Dulbecco's phosphate buffered saline containing calcium chloride and magnesium chloride, (ii) up to about 5.0 percent by weight albumin, (iii) greater than 0 up to about 6.0 percent by weight of an antibiotic-antimycotic solution, desirably, the preferred antibiotic-antimycotic solution; (iv) greater than 0 up to about 1.0 percent by weight of a putrescine-containing solution; (v) greater than 0 up to about 1.0 percent by weight of 2-mercaptoethanol; and (vi) an optional amount of sterile sodium hydroxide or sterile hydrochloric acid to provide a serum-free solution having a pH of 7.4.

In a further desired embodiment, the above-described serum-free solution comprises (a) 486 ml of the filter sterilized buffer solution, wherein the filter sterilized buffer solution comprises (i) Dulbecco's phosphate buffered saline containing calcium chloride and magnesium chloride, (ii) 0.5 percent by weight of albumin, (iii) 15 ml of the preferred antibiotic-antimycotic solution; (a) 0.1 ml of a 1M putrescine solution comprising (i) 1.61 g of putrescine; (ii) 10 ml of OPTI-MEM I with GLUTAMAX (i.e., “the second preferred cell culture solution”); and (iii) an optional amount of sterile sodium hydroxide or sterile hydrochloric acid to provide a putrescine-containing solution having a pH of 7.4; (b) 0.9 ml of a 55 mM 2-mercaptoethanol solution; and (c) an optional amount of sterile sodium hydroxide or sterile hydrochloric acid to provide a serum-free solution having a pH of 7.4.

The present invention is further directed to serum-free solutions suitable for use as a tissue harvest and storage medium for lineage-uncommitted postnatal pluripotent epiblast-like stem cells (PPELSC). One such serum-free solution comprises (a) greater than 90 percent by weight of a cell culture solution (i.e., Eagle's Minimal Essential Medium) buffered with HEPES and sodium bicarbonate, and supplemented with hypoxanthine, thymidine, sodium pyruvate, phenol red, trace elements and growth factors (i.e., OPTI-MEM I) (hereinafter referred to as “the first preferred cell culture solution”); (b) greater than 0 up to about 6.0 percent by weight of an antibiotic-antimycotic solution, desirably, the preferred antibiotic-antimycotic solution; (c) greater than 0 up to about 1.0 percent by weight of putrescine; (d) greater than 0 up to about 1.0 percent by weight of 2-mercaptoethanol; (e) greater than 0 up to about 10.0 percent by weight of albumin; (f) greater than 0 up to about 1.0 percent by weight of type-I collagen; (g) up to about 1.0 percent by weight of optional fibronectin; and (h) an optional amount of sterile sodium hydroxide or sterile hydrochloric acid to provide a serum-free solution having a pH of 7.4. In a specific solution suitable for use for diagnostic purposes, the serum-free tissue harvest and storage solution comprises (a) 484.4 ml of the first preferred cell culture solution; (b) 15.0 ml of the preferred antibiotic-antimycotic solution; (c) 0.05 mg of putrescine; (d) 0.5 ml of a 55 mM 2-mercaptoethanol solution; (e) 5.0 g of serum albumin; (f) 50 mg of type-I collagen; and (g) an optional amount of sterile sodium hydroxide or sterile hydrochloric acid to provide a serum-free solution having a pH of 7.4.

In a further embodiment, the serum-free solution suitable for use as a tissue harvest and storage medium for lineage-uncommitted postnatal pluripotent epiblast-like stem cells (PPELSC) comprises (a) greater than 90 percent by weight of a cell culture solution, desirably, the first preferred cell culture solution; (b) greater than 0 up to about 6.0 percent by weight of an antibiotic-antimycotic solution, desirably, the preferred antibiotic-antimycotic solution; (c) greater than 0 up to about 1.0 percent by weight of putrescine; (d) greater than 0 up to about 1.0 percent by weight of 2-mercaptoethanol; (e) greater than 0 up to about 10.0 percent by weight of albumin; (f) greater than 0 up to about 1.0 percent by weight of human type-I collagen; (g) greater than 0 up to about 1.0 percent by weight of fibronectin; and (h) an optional amount of sterile sodium hydroxide or sterile hydrochloric acid to provide a serum-free solution having a pH of 7.4. In a specific embodiment for human clinical purposes, the serum-free tissue harvest and storage solution suitable for use as a tissue harvest and storage medium comprises (a) 484.4 ml of the first preferred cell culture solution; (b) 5.0 ml of the preferred antibiotic-antimycotic solution; (c) 0.05 mg of putrescine; (d) 0.5 ml of a 55 mM 2-mercaptoethanol solution; (e) 5.0 g of the human serum albumin; (f) 50 mg of human type-I collagen; and (g) an optional amount of sterile sodium hydroxide or sterile hydrochloric acid to provide a serum-free solution having a pH of 7.4.

The present invention is further directed to serum-free solutions suitable for use as a cell isolation medium for lineage-uncommitted postnatal pluripotent epiblast-like stem cells (PPELSCs). One such serum-free solution comprises (a) greater than 90 percent by weight of a cell culture solution, desirably, the first preferred cell culture solution; (b) greater than 0 up to about 2.0 percent by weight of an antibiotic-antimycotic solution, desirably, the preferred antibiotic-antimycotic solution; (c) greater than 0 up to about 1.0 percent by weight of putrescine; (d) greater than 0 up to about 1.0 percent by weight of 2-mercaptoethanol; (e) greater than 0 up to about 3.0 percent by weight of albumin; (f) up to about 0.6 g of type-I collagenase; (g) about 50 ml of a dispase solution (described below); and (h) an optional amount of sterile sodium hydroxide or sterile hydrochloric acid to provide a serum-free solution having a pH of 7.4. In a specific solution suitable for use for diagnostic purposes, the serum-free cell isolation solution comprises (a) 484.4 ml of the first preferred cell culture solution; (b) 15.0 ml of the preferred antibiotic-antimycotic solution; (c) 0.05 mg of putrescine; (d) 0.5 ml of a 55 mM 2-mercaptoethanol solution; (e) 5.0 g of serum albumin; (f) 250 units per ml of collagenase; (g) 33.3 units of dispase per ml of serum-free solution; and (h) an optional amount of sterile sodium hydroxide or sterile hydrochloric acid to provide a serum-free solution having a pH of 7.4.

In a further embodiment, the serum-free solution suitable as a cell isolation medium for lineage-uncommitted postnatal pluripotent epiblast-like stem cells (PPELSC) comprises (a) greater than 90 percent by weight of a cell culture solution, desirably, the first preferred cell culture solution; (b) greater than 0 up to about 2.0 percent by weight of an antibiotic-antimycotic solution, desirably, the preferred antibiotic-antimycotic solution; (c) greater than 0 up to about 1.0 percent by weight of putrescine; (d) greater than 0 up to about 1.0 percent by weight of 2-mercaptoethanol; (e) greater than 0 up to about 3.0 percent by weight of albumin; (f) up to about 500 units per ml of type-I collagenase; (g) up to about 70 units per ml of a dispase solution, and (h) an optional amount of sterile sodium hydroxide or sterile hydrochloric acid to provide a serum-free solution having a pH of 7.4. In a specific embodiment for human clinical purposes, the serum-free cell isolation solution suitable for use as a tissue harvest and storage medium comprises (a) 484.4 ml of the first preferred cell culture solution; (b) 5.0 ml of the preferred antibiotic-antimycotic solution; (c) 0.05 mg of putrescine; (d) 0.5 ml of a 55 mM 2-mercaptoethanol solution; (e) 5.0 g of human serum albumin; (f) 250 units per ml of collagenase; (g) 33.3 units of dispase per ml of serum-free solution; and (h) an optional amount of sterile sodium hydroxide or sterile hydrochloric acid to provide a serum-free solution having a pH of 7.4.

The present invention is further directed to serum-free solutions suitable for use as a plating medium for lineage-uncommitted postnatal pluripotent epiblast-like stem cells (PPELSCs). One such serum-free solution comprises (a) greater than 90 percent by weight of a cell culture solution, desirably, the first preferred cell culture solution; (b) greater than 0 up to about 2.0 percent by weight of an antibiotic-antimycotic solution, desirably, the preferred antibiotic-antimycotic solution; (c) greater than 0 up to about 1.0 percent by weight of putrescine; (d) greater than 0 up to about 1.0 percent by weight of 2-mercaptoethanol; (e) greater than 0 up to about 10.0 percent by weight of albumin; (f) greater than 0 up to about 5.0 percent by weight of type-I collagen; (g) greater than 0 up to about 1.0 percent by weight of fibronectin; (h) greater than 0 up to about 20.0 ng/ml platelet-derived growth factor-BB (R&D Systems, Minneapolis Minn.); and (i) an optional amount of sterile sodium hydroxide or sterile hydrochloric acid to provide a serum-free solution having a pH of 7.4.

In one specific embodiment for diagnostic purposes, the serum-free plating solution comprises (a) 494.4 ml of the first preferred cell culture solution; (b) 5.0 ml of the preferred antibiotic-antimycotic solution; (c) 0.05 mg of putrescine; (d) 0.5 ml of a 55 mM 2-mercaptoethanol solution; (e) 5.0 g of albumin; (f) 5.0 g of type-I collagen; (g) 37.5 μg of fibronectin; (h) 5.0 ng/ml platelet-derived growth factor-BB; and (i) an optional amount of sterile sodium hydroxide or sterile hydrochloric acid to provide a serum-free solution having a pH of 7.4. In another specific embodiment for human clinical purposes, the serum-free plating solution comprises (a) 499.4 ml of the first preferred cell culture solution; (b) 0.05 mg of putrescine; (c) 0.5 ml of a 55 mM 2-mercaptoethanol solution; (d) 5.0 g of albumin; (e) 5.0 g of type-I collagen; (f) 37.5 μg of fibronectin; (g) 5.0 ng/ml platelet-derived growth factor-BB; and (h) an optional amount of sterile sodium hydroxide or sterile hydrochloric acid to provide a serum-free solution having a pH of 7.4.

The present invention is further directed to serum-free solutions suitable for use as a propagation medium for lineage-uncommitted postnatal pluripotent epiblast-like stem cells (PPELSCs). One such serum-free solution comprises (a) greater than 90 percent by weight of a cell culture solution, desirably, the first preferred cell culture solution; (b) greater than 0 up to about 2.0 percent by weight of an antibiotic-antimycotic solution, desirably, the preferred antibiotic-antimycotic solution; (c) greater than 0 up to about 1.0 percent by weight of putrescine; (d) greater than 0 up to about 1.0 percent by weight of 2-mercaptoethanol; (e) greater than 0 up to about 10.0 percent by weight of albumin; (f) greater than 0 up to about 1.0 percent by weight of type-I collagen; (g) greater than 0 up to about 1.0 percent by weight of fibronectin; (h) greater than 0 up to about 20.0 ng/ml platelet-derived growth factor-BB (R&D Systems, Minneapolis Minn.); and (i) an optional amount of sterile sodium hydroxide or sterile hydrochloric acid to provide a serum-free solution having a pH of 7.4.

In one specific embodiment for diagnostic purposes, the serum-free propagation solution comprises (a) 494.4 ml of the first preferred cell culture solution; (b) 5.0 ml of the preferred antibiotic-antimycotic solution; (c) 0.05 mg of putrescine; (d) 0.5 ml of a 55 mM 2-mercaptoethanol solution; (e) 1.0 g of albumin; (f) 50 mg of type-I collagen; (g) 37.5 μg of fibronectin; (h) 10.0 ng/ml platelet-derived growth factor-BB; and (i) an optional amount of sterile sodium hydroxide or sterile hydrochloric acid to provide a serum-free solution having a pH of 7.4. In another specific embodiment for human clinical purposes, the serum-free propagation solution comprises (a) 499.4 ml of the first preferred cell culture solution; (b) 0.05 mg of putrescine; (c) 0.5 ml of a 55 mM 2-mercaptoethanol solution; (d) 1.0 g of albumin; (e) 50 mg of type-I collagen; (f) 37.5 μg of fibronectin; (g) 10.0 ng/ml platelet-derived growth factor-BB; and (h) an optional amount of sterile sodium hydroxide or sterile hydrochloric acid to provide a serum-free solution having a pH of 7.4.

The present invention is even further directed to serum-free solutions suitable for use as a cell washing medium for lineage-uncommitted postnatal pluripotent epiblast-like stem cells (PPELSCs). One such serum-free solution comprises (a) greater than 90 percent by weight of a cell culture solution, desirably, the second preferred cell culture solution (i.e., OPTI-MEM I with GLUTAMAX); (b) greater than 0 up to about 2.0 percent by weight of an antibiotic-antimycotic solution, desirably, the preferred antibiotic-antimycotic solution; (c) greater than 0 up to about 1.0 percent by weight of putrescine; (d) greater than 0 up to about 1.0 percent by weight of 2-mercaptoethanol; (e) greater than 0 up to about 10.0 percent by weight of albumin; and (f) an optional amount of sterile sodium hydroxide or sterile hydrochloric acid to provide a serum-free solution having a pH of 7.4.

In one specific embodiment for diagnostic purposes, the serum-free cell washing solution comprises (a) 494.4 ml of the second preferred cell culture solution; (b) 5.0 ml of the preferred antibiotic-antimycotic solution; (c) 0.05 mg of putrescine; (d) 0.5 ml of a 55 mM 2-mercaptoethanol solution; (e) 1.0 g of bovine serum albumin; and (f) an optional amount of sterile sodium hydroxide or sterile hydrochloric acid to provide a serum-free solution having a pH of 7.4. In another specific embodiment for human clinical purposes, the serum-free cell washing solution comprises (a) 499.4 ml of the second preferred cell culture solution; (b) 0.05 mg of putrescine; (c) 0.5 ml of a 55 mM 2-mercaptoethanol solution; (d) 1.0 g of human serum albumin; and (e) an optional amount of sterile sodium hydroxide or sterile hydrochloric acid to provide a serum-free solution having a pH of 7.4.

In yet a further exemplary embodiment of the present invention, a series of four serum-free defined release solutions are necessary for releasing postnatal pluripotent epiblast-like stem cells from culture surfaces. These serum-free defined solutions, to be used in sequence, are designated release solution-A, release solution-B, release solution-C, and release solution-D.

Release solution-A comprises (a) greater than 90 percent by weight of a cell culture solution, desirably, the second preferred cell culture solution; (b) greater than 0 up to about 2.0 percent by weight of an antibiotic-antimycotic solution, desirably, the preferred antibiotic-antimycotic solution; (c) greater than 0 up to about 1.0 percent by weight of putrescine; (d) greater than 0 up to about 1.0 percent by weight of 2-mercaptoethanol; (e) greater than 0 up to about 20.0 percent by weight of albumin; and (f) an optional amount of sterile sodium hydroxide or sterile hydrochloric acid to provide a serum-free solution having a pH of 7.4.

In one specific embodiment for diagnostic purposes, the serum-free defined release solution-A comprises (a) 494.4 ml of the second preferred cell culture solution; (b) 5.0 ml of the preferred antibiotic-antimycotic solution; (c) 0.05 mg of putrescine; (d) 0.5 ml of a 55 mM 2-mercaptoethanol solution; (e) 10.0 g of serum albumin; and (f) an optional amount of sterile sodium hydroxide or sterile hydrochloric acid to provide a serum-free solution having a pH of 7.4. In another specific embodiment for human clinical purposes, the serum-free defined release solution-A comprises (a) 499.4 ml of the second preferred cell culture solution; (b) 0.05 mg of putrescine; (c) 0.5 ml of a 55 mM 2-mercaptoethanol solution; (d) 10.0 g of human serum albumin; and (e) an optional amount of sterile sodium hydroxide or sterile hydrochloric acid to provide a serum-free solution having a pH of 7.4.

Release solution-B comprises (a) greater than 90 percent by weight of the Dulbecco's phosphate buffered saline optionally containing calcium chloride and magnesium chloride; (b) greater than 0 up to about 2.0 percent by weight of an antibiotic-antimycotic solution, desirably, the preferred antibiotic-antimycotic solution; (c) greater than 0 up to about 1.0 percent by weight of putrescine; (d) greater than 0 up to about 1.0 percent by weight of 2-mercaptoethanol; and (e) an optional amount of sterile sodium hydroxide or sterile hydrochloric acid to provide a serum-free solution having a pH of 7.4.

In one specific embodiment for diagnostic purposes, the serum-free defined release solution-B comprises (a) 494.4 ml of the Dulbecco's solution containing calcium chloride and magnesium chloride; (b) 5.0 ml of the preferred antibiotic-antimycotic solution; (c) 0.05 mg of putrescine; (d) 0.5 ml of a 55 mM 2-mercaptoethanol solution; and (e) an optional amount of sterile sodium hydroxide or sterile hydrochloric acid to provide a serum-free solution having a pH of 7.4. In another specific embodiment for human clinical purposes, the serum-free defined release solution-B comprises (a) 499.4 ml of the Dulbecco's solution containing calcium chloride and magnesium chloride; (b) 0.05 mg of putrescine; (c) 0.5 ml of a 55 mM 2-mercaptoethanol solution; and (d) an optional amount of sterile sodium hydroxide or sterile hydrochloric acid to provide a serum-free solution having a pH of 7.4.

Release solution-C comprises (a) greater than 90 percent by weight of the Dulbecco's phosphate buffered saline without calcium chloride and without magnesium chloride; (b) greater than 0 up to about 2.0 percent by weight of an antibiotic-antimycotic solution, desirably, the preferred antibiotic-antimycotic solution; (c) greater than 0 up to about 1.0 percent by weight of putrescine; (d) greater than 0 up to about 1.0 percent by weight of 2-mercaptoethanol; (e) greater than 0 up to 5.0 ml of a 1.0 M solution of ethylenediamine tetraacetic acid (EDTA); and (f) an optional amount of sterile sodium hydroxide or sterile hydrochloric acid to provide a serum-free solution having a pH of 7.4.

In one specific embodiment for diagnostic purposes, the serum-free defined release solution-C comprises (a) 492.3 ml of the Dulbecco's phosphate buffered saline solution without calcium chloride and without magnesium chloride; (b) 5.0 ml of the preferred antibiotic-antimycotic solution; (c) 0.05 mg of putrescine; (d) 0.5 ml of a 55 mM 2-mercaptoethanol solution; (e) 2.2 ml of a 0.5 M solution of EDTA; and (f) an optional amount of sterile sodium hydroxide or sterile hydrochloric acid to provide a serum-free solution having a pH of 7.4. In another specific embodiment for human clinical purposes, the serum-free defined release solution-C comprises (a) 497.3 ml of the Dulbecco's phosphate buffered saline solution without calcium chloride and without magnesium chloride; (b) 0.05 mg of putrescine; (c) 0.5 ml of a 55 mM 2-mercaptoethanol solution; (c) 2.2 ml of a 0.5 M solution of EDTA; and (e) an optional amount of sterile sodium hydroxide or sterile hydrochloric acid to provide a serum-free solution having a pH of 7.4.

Release solution-D comprises (a) greater than 90 percent by weight of the Dulbecco's phosphate buffered saline without calcium chloride and without magnesium chloride; (b) greater than 0 up to about 2.0 percent by weight of an antibiotic-antimycotic solution, desirably, the preferred antibiotic-antimycotic solution; (c) greater than 0 up to about 1.0 percent by weight of putrescine; (d) greater than 0 up to about 1.0 percent by weight of 2-mercaptoethanol; (e) greater than 0 up to 5.0 ml of greater than 0 up to a 1.0 M solution of EDTA; (f) greater than 0 up to 100 mg trypsin; and (g) an optional amount of sterile sodium hydroxide or sterile hydrochloric acid to provide a serum-free solution having a pH of 7.4.

In one specific embodiment for diagnostic purposes, the serum-free defined release solution-D comprises (a) 492.3 ml of the Dulbecco's phosphate buffered saline solution without calcium chloride and without magnesium chloride; (b) 5.0 ml of the preferred antibiotic-antimycotic solution; (c) 0.05 mg of putrescine; (d) 0.5 ml of a 55 mM 2-mercaptoethanol solution; (e) 2.2 ml of a 0.5 M solution of EDTA; (f) 50 mg trypsin; and (g) an optional amount of sterile sodium hydroxide or sterile hydrochloric acid to provide a serum-free solution having a pH of 7.4. In another specific embodiment for human clinical purposes, the serum-free defined release solution-D comprises (a) 497.3 ml of the Dulbecco's phosphate buffered saline solution without calcium chloride and without magnesium chloride; (b) 0.05 mg of putrescine; (c) 0.5 ml of a 55 mM 2-mercaptoethanol solution; (c) 2.2 ml of a 0.5 M solution of EDTA; (e) 50 mg trypsin; and (f) an optional amount of sterile sodium hydroxide or sterile hydrochloric acid to provide a serum-free solution having a pH of 7.4.

In the above-described serum-free solutions of the present invention, the albumin used in the compositions may comprise bovine serum albumin to prepare solutions suitable for diagnostic purposes, or human serum albumin to prepare solutions suitable for human clinical purposes.

The present invention is further directed to serum-free solutions suitable for use as a cryopreservation medium for lineage-uncommitted postnatal pluripotent epiblast-like stem cells (PPELSCs). One such serum-free solution comprises (a) greater than 90 percent by weight of a cell culture solution, desirably, the first preferred cell culture solution; (b) greater than 0 up to about 2.0 percent by weight of an antibiotic-antimycotic solution, desirably, the preferred antibiotic-antimycotic solution; (c) greater than 0 up to about 1.0 percent by weight of putrescine; (d) greater than 0 up to about 1.0 percent by weight of 2-mercaptoethanol; (e) greater than 0 up to about 20.0 percent by weight of albumin; (f) greater than 0 up to about 1.0 percent by weight of type-I collagen; (g) greater than 0 up to about 1.0 percent by weight of fibronectin; (h) greater than 0 up to about 20.0 ng/ml platelet-derived growth factor-BB (R&D Systems, Minneapolis Minn.); (i) greater than 0 up to about 500 μl/ml dimethylsulfoxide; and (j) an optional amount of sterile sodium hydroxide or sterile hydrochloric acid to provide a serum-free solution having a pH of 7.4.

In one specific embodiment for diagnostic purposes, the serum-free cryopreservation solution comprises (a) 494.25 ml of the first preferred cell culture solution; (b) 5.0 ml of the preferred antibiotic-antimycotic solution; (c) 0.05 mg of putrescine; (d) 0.5 ml of a 55 mM 2-mercaptoethanol solution; (e) 1.0 g of albumin; (f) 50 mg of type-I collagen; (g) 37.5 μg of fibronectin; (h) 5.0 ng/ml platelet-derived growth factor-BB; (i) 150 μl/ml of 99.999% pure dimethyl sulfoxide; and (j) an optional amount of sterile sodium hydroxide or sterile hydrochloric acid to provide a serum-free solution having a pH of 7.4. In another specific embodiment for human clinical purposes, the serum-free cryopreservation solution comprises (a) 499.25 ml of the first preferred cell culture solution; (b) 0.05 mg of putrescine; (c) 0.5 ml of a 55 mM 2-mercaptoethanol solution; (d) 1.0 g of albumin; (e) 50 mg of type-I collagen; (f) 37.5 μg of fibronectin; (g) 5.0 ng/ml platelet-derived growth factor-BB; (h) μl/ml of 99.999% pure dimethyl sulfoxide; and (i) an optional amount of sterile sodium hydroxide or sterile hydrochloric acid to provide a serum-free solution having a pH of 7.4.

II. Methods of Making Specific Serum-Free Solutions

The present invention is further directed to methods of making the above-mentioned serum-free solutions. Methods of making a variety of specific serum-free solutions are provided below.

A. Antibiotic-Antimycotic Solution

In one embodiment, the preferred antibiotic-antimycotic solution comprises 10,000 units/ml Penicillin G, 10,000 μg/ml Streptomycin, and 25 μg/ml Amphotericin B and is commercially available from Mediatech (Cellgro, Herndon, Va.) as a 100X solution. The 100X preferred antibiotic-antimycotic solution is added to serum-free solutions at a range of 0 to 6 mls per 100 ml solution (0 to 30 mls per 500 ml) for a final concentration range of 0 to 6%. Alternate solutions utilized with the cultured cells include similar 100X antibiotic-antimycotic solutions obtained from other companies, e.g., 10,000 units/ml Penicillin G, 10,000 μg/ml Streptomycin, and 25 μg/ml Amphotericin B [GIBCO (Invitrogen Corporation, Carlsbad, Calif.) 100X], or various combinations or single versions of sterile antibiotic(s) and/or antimycotic(s) (from any company) necessary to prevent microbiological contamination of the cultured cells, i.e., 10,000 units/ml Penicillin G and 10,000 μg/ml Streptomycin [either Mediatech or GIBCO]; 10,000 units/ml Penicillin G [either Mediatech or GIBCO]; 10,000 μg/ml Streptomycin [either Mediatech or GIBCO]; and 25 μg/ml Amphotericin B [either Mediatech or GIBCO] alone or in combination with one another.

B. Disinfectant

The disinfectant of choice is Amphyl solution (Reckitt & Coleman Inc., Montvale, N.J.): 0.5% (v/v) in deionized water. In a 20 L carboy, mix 100 ml of Amphyl with 19.9 L of deionized water. Swirl the carboy gently to mix the contents. However, 70% ethanol or other disinfectants not harmful to the cells may be utilized.

C. 70% (v/v) Ethanol

Dilute 95% ethanol (Fisher Scientific, Pittsburgh, Pa.) to 70% (v/v) with double deionized water. In a 500 ml glass media bottle, mix 368.4 ml of 95% ethanol with 131.6 ml of double deionized water.

D. Bleach Solution

0.5% Sodium hypochlorite (undiluted Clorox) in a 2 L Erlenmeyer flask.

E. 0.4% Trypan Blue Solution

Weigh out 0.2 g of trypan blue (Sigma, St. Louis, Mo.) and place it in a sterile 100 ml glass media bottle. Under sterile conditions using a 25 ml pipet, add 50 ml of Dulbecco's phosphate buffered saline (DPBS) with calcium chloride and magnesium chloride (GIBCO/Invitrogen Corporation, Carlsbad, Calif.) containing 1% of the preferred antibiotic-antimycotic solution (Mediatech [Cellgro], Herndon, Va.), at pH 7.4. Swirl the bottle gently to dissolve the trypan blue powder. Filter sterilize the trypan blue solution by passing it through a 0.2 μm bottle-top vacuum filter (VWR, Bristol, Conn.) into a 100 ml glass media bottle.

F. 8% Gelatin Solution

Weigh 4 g of gelatin granules (type-I collagen, Gelatin NF, EM Science, Gibbstown, N.J.). Add the gelatin granules to a sterile 100 ml media bottle. Next, under sterile conditions, add 50 ml of OPTI-MEM I with GLUTAMAX (GIBCO/Invitrogen Corporation, Carlsbad, Calif.). Swirl the bottle gently to dissolve the contents of the bottle. Loosely tighten the cap of the bottle and place the bottle in the autoclave. Autoclave the mixture on the 15 minute liquid cycle. Once the autoclave cycle is complete, carefully remove the solution and allow it to cool to 40° C.

G. 8% Human Type-I Collagen Solution

Weigh 4 g of human type-I collagen. Add the collagen to a sterile 100 ml media bottle. Next, under sterile conditions, add 50 ml of OPTI-MEM I with GLUTAMAX (GIBCO/Invitrogen Corporation, Carlsbad, Calif.). Swirl the bottle gently to dissolve the contents of the bottle. Loosely tighten the cap of the bottle and place the bottle in the autoclave. Autoclave the mixture on the 15 minute liquid cycle. Once the autoclave cycle is complete, carefully remove the solution and allow it to cool to 40° C.

H. 16% Gelatin Solution

Weigh 8 g of gelatin granules (type-I collagen, Gelatin NF, EM Science, Gibbstown, N.J.). Add the gelatin granules to a sterile 100 ml media bottle. Next, under sterile conditions, add 50 ml of OPTI-MEM I with GLUTAMAX (GIBCO/Invitrogen Corporation, Carlsbad, Calif.). Swirl the bottle gently to dissolve the contents of the bottle. Loosely tighten the cap of the bottle and place the bottle in the autoclave. Autoclave the mixture on the 15 minute liquid cycle. Once the autoclave cycle is complete, carefully remove the solution and allow it to cool to 40° C.

I. 16% Human Type-I Collagen Solution

Weigh 8 g of human type-I collagen. Add the collagen to a sterile 100 ml media bottle. Next, under sterile conditions, add 50 ml of OPTI-MEM I with GLUTAMAX (GIBCO/Invitrogen Corporation, Carlsbad, Calif.). Swirl the bottle gently to dissolve the contents of the bottle. Loosely tighten the cap of the bottle and place the bottle in the autoclave. Autoclave the mixture on the 15 minute liquid cycle. Once the autoclave cycle is complete, carefully remove the solution and allow it to cool to 40° C.

J. Sterile 5M Sodium Hydroxide

Weigh out 20 g of sodium hydroxide (Sigma, St. Louis, Mo.) granules and add them to a glass media bottle. Very slowly add 100 ml of double deionized water to the sodium hydroxide granules. Once the sodium hydroxide is dissolved, filter sterilize the solution by passing it through a 0.1 μm bottle top vacuum filter (VWR, Bristol, Conn.) into a 500 ml glass media bottle.

K. Sterile 5M Hydrochloric Acid

Measure 41.67 ml of double deionized distilled water. Add the water to a sterile 500 ml media bottle. Measure 208.33 ml of 6N hydrochloric acid (Sigma, St. Louis, Mo.). Very slowly add the hydrochloric acid to the bottle containing the water. Swirl the bottle gently to mix the contents. Filter sterilize the solution by passing it through a 0.1 μm bottle top vacuum filter (VWR, Bristol, Conn.) into a 500 ml glass media bottle.

L. PPELSC-DP-MACS Buffer

Under sterile conditions, take a fresh 500 ml bottle of Dulbecco's Phosphate Buffered Saline with calcium and magnesium (DPBS-Ca⁺² & Mg⁺²) (GIBCO/Invitrogen Corporation, Carlsbad, Calif.). Add 0.5% w/v bovine serum albumin (Sigma, St. Louis, Mo.) and add 2 mM EDTA (GIBCO/Invitrogen Corporation, Carlsbad, Calif.). Add a stirring bar to the mixture, and stir on a stirring plate at medium speed for 1 hour at ambient temperature. Filter the solution by passing it through a 0.45 μm bottle-top filter (VWR, Bristol, Conn.) into a sterile 500 ml bottle. Filter sterilize the solution by passing it through a 0.2 μm bottle-top filter (VWR, Bristol, Conn.) into a sterile 500 ml bottle. Use the above-described sterile 5M sodium hydroxide and/or sterile 5M hydrochloric acid to adjust the pH of the solution to 7.2.

M. PPELSC-HC-MACS Buffer

Under sterile conditions, take a fresh 500 ml bottle of Dulbecco's Phosphate Buffered Saline with calcium and magnesium (DPBS-Ca⁺² & Mg⁺²). Add 0.5% w/v human albumin and add 2 mM EDTA. Add a stirring bar to the mixture, and stir on a stirring plate at medium speed for 1 hour at ambient temperature. Filter the solution by passing it through a 0.45 μm bottle-top filter into a sterile 500 ml bottle. Filter sterilize the solution by passing it through a 0.2 μm bottle-top filter into a sterile 500 ml bottle. Use the above-described sterile 5M sodium hydroxide and/or sterile 5M hydrochloric acid to adjust the pH of the solution to 7.2.

N. 1.0 M Putrescine, Sterile

Weigh 1.61 g of putrescine (1,4-diaminobutane dihydrochloride) (Sigma, St. Louis, Mo.). Add the putrescine to a sterile 15 ml conical tube. Next, under sterile conditions, add 10 ml of OPTI-MEM I with GLUTAMAX (GIBCO/Invitrogen Corporation, Carlsbad, Calif.). Invert tube to dissolve contents. Place contents in a 20 cc sterile syringe. Filter sterilize through a 0.2 μm syringe filter (VWR, Bristol, Conn.). Use the above-described sterile 5M sodium hydroxide and/or sterile 5M hydrochloric acid to adjust the pH of the solution to 7.4.

O. SFD-PPELSC-DP/HC-Tissue Wash

Under sterile conditions, take a fresh 500 ml bottle of DPBS-Ca⁺² & Mg⁺², (GIBCO/Invitrogen Corporation, Carlsbad, Calif.) discard 16 ml by placing it in the above-described bleach solution, and then add 15 ml of the preferred antibiotic-antimycotic solution (10,000 units/ml Penicillin G, 10,000 μg/ml Streptomycin, 25 μg/ml Amphotericin B [Mediatech (Cellgro, Herndon, Va.); 100X]), 0.1 ml of the above-described 1 M putrescine solution, and 0.9 ml of a 55 mM 2-mercaptoethanol solution (GIBCO/Invitrogen Corporation, Carlsbad, Calif.). Swirl the bottle gently to mix the contents. Use the above-described sterile 5M sodium hydroxide and/or sterile 5M hydrochloric acid to adjust the pH of the solution to 7.4.

P. Fibronectin Solution

Dissolve 5 mg of sterile fibronectin (Sigma, St. Louis, Mo.) in 5 ml of sterile OPTI-MEM I with GLUTAMAX (GIBCO/Invitrogen Corporation, Carlsbad, Calif.). Gently swirl bottle to dissolve.

Q. SFD-PPELSC-DP-Harvest and Storage Medium

Under sterile conditions, take a fresh 500 ml bottle of OPTI-MEM I with GLUTAMAX (GIBCO/Invitrogen Corporation, Carlsbad, Calif.). Discard 15.6 ml by placing it in the above-described bleach solution, and then add 15 ml of the preferred antibiotic-antimycotic solution (10,000 units/ml Penicillin G, 10,000 μg/ml Streptomycin, 25 μg/ml Amphotericin B [Mediatech (Cellgro, Herndon, Va.); 100X]). Add 0.1 ml of the above-described 1M putrescine solution. Add 0.5 ml of a 55 mM 2-mercaptoethanol solution (GIBCO/Invitrogen Corporation, Carlsbad, Calif.). Add 5 g of bovine serum albumin (BSA) (Sigma, St. Louis, Mo.). Add a sterile stirring bar. Stir the solution on medium speed until the BSA dissolves. Add 0.625 ml of the above-described 8% gelatin solution. Add 37.5 μl of the above-described sterile fibronectin solution. Stir the solution on medium speed until all the components have dissolved. Filter sterilize the solution by passing it through a 0.2 μm bottle-top filter (VWR, Bristol, Conn.) into a sterile 500 ml glass media bottle. Filter sterilize the solution a second time by passing it through a 0.1 μm bottle-top filter (VWR, Bristol, Conn.) into a sterile 500 ml glass media bottle. Use the above-described sterile 5M sodium hydroxide and/or sterile 5M hydrochloric acid to adjust the pH of the solution to 7.4.

R. SFD-PPELSC-HC-Harvest and Storage Medium

Under sterile conditions, take a fresh 500 ml bottle of OPTI-MEM I with GLUTAMAX. Discard 0.6 ml by placing it in the above-described bleach solution, and then add 0.1 ml of the above-described 1 M putrescine solution. Add 0.5 ml of a 55 mM 2-mercaptoethanol solution. Add 5 g of human serum albumin. Add a sterile stirring bar. Stir the solution on medium speed until the albumin dissolves. Add 0.625 ml of the above-described 8% human type-I collagen solution. Add 37.5 μl of the above-described sterile fibronectin solution. Stir the solution on medium speed until all the components are dissolved. Filter sterilize the solution by passing it through a 0.2 μm bottle-top filter into a sterile 500 ml glass media bottle. Filter sterilize the solution by passing it through a 0.1 μm bottle-top filter into a sterile 500 ml glass media bottle. Use the above-described sterile 5M sodium hydroxide and/or sterile 5M hydrochloric acid to adjust the pH of the solution to 7.4.

S. SFD-PPELSC-DP-Cell Isolation Medium

Under sterile conditions, take a fresh 500 ml bottle of OPTI-MEM I with GLUTAMAX (GIBCO/Invitrogen Corporation, Carlsbad, Calif.). Discard 15.6 ml by placing it in the above-described bleach solution, and then add 15 ml of the preferred antibiotic-antimycotic solution (10,000 units/ml Penicillin G, 10,000 μg/ml Streptomycin, 25 μg/ml Amphotericin B [Mediatech (Cellgro, Herndon, Va.); 100X]). Add 100 μl of the above-described 1M putrescine (Sigma, St. Louis, Mo.) solution. Add 0.5 ml of a 55 mM 2-mercaptoethanol solution (GIBCO/Invitrogen Corporation, Carlsbad, Calif.). Add 5 g of bovine serum albumin (BSA) (Sigma, St. Louis, Mo.). Add a sterile stirring bar. Stir the solution on medium speed until the BSA dissolves. Add 0.625 ml of the above-described 8% gelatin solution. Add 37.5 μl of the above-described sterile fibronectin solution. Stir the solution on medium speed until all the components have dissolved. Filter sterilize the solution by passing it through a 0.2 μm bottle-top filter (VWR, Bristol, Conn.) into a sterile 500 ml glass media bottle. Filter sterilize the solution a second time by passing it through a 0.1 μm bottle-top filter (VWR, Bristol, Conn.) into a sterile 500 ml glass media bottle. Use the above-described sterile 5M sodium hydroxide and/or sterile 5M hydrochloric acid to adjust the pH of the solution to 7.4 forming an intermediate medium.

Weigh out 0.304 g, 75,000 units, of type-I collagenase (Worthington Biochemical Corporation, Lakewood, N.J.). Add the collagenase to a sterile 500 ml glass media bottle. Next, under sterile conditions, add 100 ml of the above-described intermediate medium. Add a sterile stirring bar to the mixture, and stir on a stirring plate at medium speed for 1 hour at ambient temperature. Filter the collagenase after one hour. Label four sterile 500 ml media bottles #1-4. Sterilize a BD Falcon bottle top-filter apparatus (VWR, Bristol, Conn.) with the above-described 70% ethanol solution. Once the ethanol has evaporated, assemble a BD Falcon bottle-top filter apparatus with a glass microfiber pre-filter and place it on bottle #1. Attach the tubing from a vacuum pump and vacuum filter the collagenase solution. Sterilize a BD Falcon bottle-top filter apparatus with the above-described 70% ethanol solution. Once the ethanol has evaporated, assemble a BD Falcon bottle-top filter apparatus with a glass microfiber pre-filter and place it on bottle #2. Attach the tubing from a vacuum pump and vacuum filter the collagenase solution a second time. Then, assemble another 70% ethanol sterilized BD Falcon bottle-top filter apparatus with a 0.45 μm filter (VWR, Bristol, Conn.) and a pre-filter and place it on bottle #3. Attach the tubing from a vacuum pump and filter the collagenase solution through the 0.45 μm filter. Filter the collagenase solution through a 0.2 μm bottle-top filter (VWR, Bristol, Conn.) into bottle #4. The collagenase solution is now sterile and prepared for introduction into a dispase solution (Collaborative Biomedical Products, Bedford, Mass.). Add 100 ml of the dispase solution to another 500 ml sterile media bottle. Next, add 50 ml of sterile collagenase solution to the bottle containing 100 ml of dispase solution. This gives a final concentration of 250 units/ml of collagenase+33.3 units/ml of dispase. Aliquot 10 ml of the collagenase/dispase solution into 15×15 ml centrifuge tubes. Store the tubes at −20° C. until needed.

T. SFD-PPELSC-HC-Cell Isolation Medium

Under sterile conditions, take a fresh 500 ml bottle of OPTI-MEM I with GLUTAMAX. Discard 0.6 ml by placing it in the above-described bleach solution, and then add 100 μl of the above-described 1M putrescine solution. Add 0.5 ml of 55 mM 2-mercaptoethanol. Add 5 g of human albumin. Add a sterile stirring bar. Stir the solution on medium speed until the albumin dissolves. Add 0.625 ml of the above-described 8% human type-I collagen solution. Add 37.5 μl of sterile fibronectin solution. Stir the solution on medium speed until all the components are dissolved. Filter sterilize the solution by passing it through a 0.2 μm bottle-top filter into a sterile 500 ml glass media bottle. Filter sterilize the solution by passing it through a 0.1 μm bottle-top filter into a sterile 500 ml glass media bottle. Use the above-described sterile 5M sodium hydroxide and/or sterile 5M hydrochloric acid to adjust the pH of the solution to 7.4 forming an intermediate medium.

Weigh out 0.304 g, 75,000 units, of type-I collagenase. Add the collagenase to a sterile 500 ml glass media bottle. Next, under sterile conditions, add 100 ml of the above-described intermediate medium. Add a sterile stirring bar to the mixture, and stir on a stirring plate at medium speed for 1 hour at ambient temperature. Filter the collagenase after one hour. Label four sterile 500 ml media bottles #1-4. Sterilize a BD Falcon bottle top-filter apparatus with the above-described 70% ethanol solution. Once the ethanol has evaporated, assemble a BD Falcon bottle-top filter apparatus with a glass microfiber pre-filter and place it on bottle #1. Attach the tubing from a vacuum pump and vacuum filter the collagenase solution. Sterilize a BD Falcon bottle-top filter apparatus with the above-described 70% ethanol solution. Once the ethanol has evaporated, assemble a BD Falcon bottle-top filter apparatus with a glass microfiber pre-filter and place it on bottle #2. Attach the tubing from a vacuum pump and vacuum filter the collagenase solution a second time. Then, assemble another 70% ethanol sterilized BD Falcon bottle-top filter apparatus with a 0.45 μm filter and a pre-filter and place it on bottle #3. Attach the tubing from a vacuum pump and filter the collagenase solution through the 0.45 μm filter. Filter the collagenase solution through a 0.2 μm bottle-top filter into bottle #4. The collagenase solution is now sterile and prepared for introduction into a dispase solution, such as the above-described dispase solution. Add 100 ml of the dispase solution to another 500 ml sterile media bottle. Next, add 50 ml of sterile collagenase solution to the bottle containing 100 ml of dispase solution. This gives a final concentration of 250 units/ml of collagenase+33.3 units/ml of dispase. Aliquot 10 ml of the collagenase/dispase solution into 15×15 ml centrifuge tubes. Store the tubes at −20° C. until needed.

U. SFD-PPELSC-DP-Plating Medium

Under sterile conditions, take a fresh 500 ml bottle of OPTI-MEM I with GLUTAMAX (GIBCO/Invitrogen Corporation, Carlsbad, Calif.), remove 31.25 ml, and then add 31.25 ml of the above-described 16% stock collagen solution. Swirl the bottle gently to mix the contents. Discard 5.6 ml by placing it in the above-described bleach solution, and then add 5 ml of the preferred antibiotic-antimycotic solution (10,000 units/ml Penicillin G, 10,000 μg/ml Streptomycin, 25 μg/ml Amphotericin B [Mediatech (Cellgro, Herndon, Va.); 100X]). Add 0.1 ml of the above-described 1M putrescine solution. Add 0.5 ml of a 55 mM 2-mercaptoethanol solution (GIBCO/Invitrogen Corporation, Carlsbad, Calif.). Add 10 g of bovine serum albumin (BSA) (Sigma, St. Louis, Mo.). Add a sterile stirring bar. Stir the solution on medium speed until the BSA dissolves. Add 37.5 μl of the above-described sterile fibronectin solution. Stir the solution on medium speed until all the components have dissolved. Filter sterilize the solution by passing it through a 0.2 μm bottle-top filter (VWR, Bristol, Conn.) into a sterile 500 ml glass media bottle. Filter sterilize the solution a second time by passing it through a 0.1 μm bottle-top filter (VWR, Bristol, Conn.) into a sterile 500 ml glass media bottle. Use the above-described sterile 5M sodium hydroxide and/or sterile 5M hydrochloric acid to adjust the pH of the solution to 7.4. Add 5 ng recombinant-human platelet-derived growth factor-BB (Collaborative Biomedical Products, Bedford, Mass.) per ml of solution. Swirl the bottle gently to mix the contents.

V. SFD-PPELSC-HC-Plating Medium

Under sterile conditions, take a fresh 500 ml bottle of OPTI-MEM I with GLUTAMAX, remove 31.25 ml, and then add 31.25 ml of the above-described 16% stock human type-I collagen solution. Swirl the bottle gently to mix the contents. Discard 0.6 ml by placing it in the above-described bleach solution, and then add 100 μl of the above-described 1M putrescine solution. Add 0.5 ml of a 55 mM 2-mercaptoethanol solution. Add 10 g of human serum albumin. Add a sterile stirring bar. Stir the solution on medium speed until the albumin dissolves. Add 37.5 μl of the above-described sterile fibronectin solution. Stir the solution on medium speed until all the components have dissolved. Filter sterilize the solution by passing it through a 0.2 μm bottle-top filter into a sterile 500 ml glass media bottle. Filter sterilize the solution a second time by passing it through a 0.1 μm bottle-top filter into a sterile 500 ml glass media bottle. Use the above-described sterile 5M sodium hydroxide and/or sterile 5M hydrochloric acid to adjust the pH of the solution to 7.4. Add 5 ng recombinant-human platelet-derived growth factor-BB per ml of solution. Swirl the bottle gently to mix the contents.

W. SFD-PPELSC-DP-Propagation Medium

Under sterile conditions, take a fresh 500 ml bottle of OPTI-MEM I with GLUTAMAX (GIBCO/Invitrogen Corporation, Carlsbad, Calif.). Discard 5.6 ml by placing it in the above-described bleach solution, and then add 5 ml of the preferred antibiotic-antimycotic solution (10,000 units/ml Penicillin G, 10,000 μg/ml Streptomycin, 25 μg/ml Amphotericin B [Mediatech (Cellgro, Herndon, Va.); 100X]). Add 0.1 ml of the above-described 1M putrescine solution. Add 0.5 ml of a 55 mM 2-mercaptoethanol solution (GIBCO/Invitrogen Corporation, Carlsbad, Calif.). Add 1.0 g of bovine serum albumin (BSA) (Sigma, St. Louis, Mo.). Add a sterile stirring bar. Stir the solution on medium speed until the BSA dissolves. Add 0.625 ml of the above-described 8% gelatin solution. Add 37.5 μl of the above-described sterile fibronectin solution. Stir the solution on medium speed until all the components have dissolved. Filter sterilize the solution by passing it through a 0.2 μm bottle-top filter (VWR, Bristol, Conn.) into a sterile 500 ml glass media bottle. Filter sterilize the solution a second time by passing it through a 0.1 μm bottle-top filter (VWR, Bristol, Conn.) into a sterile 500 ml glass media bottle. Use the above-described sterile 5M sodium hydroxide and/or sterile 5M hydrochloric acid to adjust the pH of the solution to 7.4. Add 10.0 ng recombinant-human platelet-derived growth factor-BB (R&D Systems, Minneapolis Minn.) per ml of solution. Swirl the bottle gently to mix the contents.

X. SFD-PPELSC-HC-Propagation Medium

Under sterile conditions, take a fresh 500 ml bottle of OPTI-MEM I with GLUTAMAX. Discard 0.6 ml by placing it in the above-described bleach solution, and then add 0.1 ml of the above-described 1M putrescine solution. Add 0.5 ml of a 55 mM 2-mercaptoethanol solution. Add 1.0 g of human serum albumin. Add a sterile stirring bar. Stir the solution on medium speed until the albumin dissolves. Add 0.625 ml of the above-described 8% human type-I collagen solution. Add 37.5 μl of the above-described sterile fibronectin solution. Stir the solution on medium speed until all components have dissolved. Filter sterilize the solution by passing it through a 0.2 μm bottle-top filter into a sterile 500 ml glass media bottle. Filter sterilize the solution a second time by passing it through a 0.1 μm bottle-top filter into a sterile 500 ml glass media bottle. Use the above-described sterile 5M sodium hydroxide and/or sterile 5M hydrochloric acid to adjust the pH of the solution to 7.4. Add 10.0 ng recombinant-human platelet-derived growth factor-BB per ml of solution. Swirl the bottle gently to mix the contents.

Y. SFD-PPELSC-DP-Cell Wash

Under sterile conditions, take a fresh 500 ml bottle of OPTI-MEM I with GLUTAMAX (GIBCO/Invitrogen Corporation, Carlsbad, Calif.), discard 5.6 ml by placing it in the above-described bleach solution, and then add 5 ml of the preferred antibiotic-antimycotic solution (10,000 units/ml Penicillin G, 10,000 μg/ml Streptomycin, and 25 μg/ml Amphotericin B [Mediatech (Cellgro, Herndon, Va.); 100X]). Add 0.1 ml of the above-described 1M putrescine solution. Add 0.5 ml of a 55 mM 2-mercaptoethanol solution (GIBCO/Invitrogen Corporation, Carlsbad, Calif.). Add 1% (w/v) of bovine serum albumin (BSA) (Sigma, St. Louis, Mo.). Add a sterile stirring bar. Stir the solution on medium speed until the albumin dissolves. Filter sterilize the solution by passing it through a 0.2 μm bottle-top filter (VWR, Bristol, Conn.) into a sterile 500 ml glass media bottle. Filter sterilize the solution a second time by passing it through a 0.1 μm bottle-top filter (VWR, Bristol, Conn.) into a sterile 500 ml glass media bottle. Use the above-described sterile 5M sodium hydroxide and/or sterile 5M hydrochloric acid to adjust the pH of the solution to 7.4.

Z. SFD-PPELSC-HC-Cell Wash

Under sterile conditions, take a fresh 500 ml bottle of OPTI-MEM I with L-glutamine, discard 0.6 ml by placing it in the above-described bleach solution, and then add 0.1 ml of the above-described 1M putrescine solution. Add 0.5 ml of a 55 mM 2-mercaptoethanol solution. Add 1% (w/v) of human albumin. Add a sterile stirring bar. Stir the solution on medium speed until the albumin dissolves. Filter sterilize the solution by passing it through a 0.2 μm bottle-top filter into a sterile 500 ml glass media bottle. Filter sterilize the solution a second time by passing it through a 0.1 μm bottle-top filter into a sterile 500 ml glass media bottle. Use the above-described sterile 5M sodium hydroxide and/or sterile 5M hydrochloric acid to adjust the pH of the solution to 7.4.

AA. SFD-PPELSC-DP-Release Solution A

Under sterile conditions, take a fresh 500 ml bottle of OPTI-MEM I with GLUTAMAX (GIBCO/Invitrogen Corporation, Carlsbad, Calif.), discard 5.6 ml by placing it in the above-described bleach solution, and then add 5 ml of the preferred antibiotic-antimycotic solution (10,000 units/ml Penicillin G, 10,000 μg/ml Streptomycin, and 25 μg/ml Amphotericin B [Mediatech (Cellgro, Herndon, Va.); 100X]). Add 0.1 ml of the above-described 1M putrescine solution. Add 0.5 ml of a 55 mM 2-mercaptoethanol solution (GIBCO/Invitrogen Corporation, Carlsbad, Calif.). Add 10% (w/v) (50 g) of bovine serum albumin (BSA) (Sigma, St. Louis, Mo.). Add a sterile stirring bar. Stir the solution on medium speed until the BSA dissolves. Filter sterilize the solution by passing it through a 0.2 μm bottle-top filter (VWR, Bristol, Conn.) into a sterile 500 ml glass media bottle. Filter sterilize the solution a second time by passing it through a 0.1 μm bottle-top filter (VWR, Bristol, Conn.) into a sterile 500 ml glass media bottle. Use the above-described sterile 5M sodium hydroxide and/or sterile 5M hydrochloric acid to adjust the pH of the solution to 7.4.

BB. SFD-PPELSC-HC-Release Solution A

Under sterile conditions, take a fresh 500 ml bottle of OPTI-MEM I with L-glutamine (Opti-MEM I with GLUTAMAX), discard 0.6 ml by placing it in the above-described bleach solution, and then add 0.1 ml of the above-described 1M putrescine solution. Add 0.5 ml of a 55 mM 2-mercaptoethanol solution. Add 5% (w/v) (25 g) of human albumin. Add a sterile stirring bar. Stir the solution on medium speed until the albumin dissolves. Filter sterilize the solution by passing it through a 0.2 μm bottle-top filter into a sterile 500 ml glass media bottle. Filter sterilize the solution a second time by passing it through a 0.1 μm bottle-top filter into a sterile 500 ml glass media bottle. Use the above-described sterile 5M sodium hydroxide and/or sterile 5M hydrochloric acid to adjust the pH of the solution to 7.4.

CC. SFD-PPELSC-DP-Release Solution B

Under sterile conditions, take a fresh 500 ml bottle of Dulbecco's phosphate buffered saline (DPBS) with calcium and magnesium (GIBCO/Invitrogen Corporation, Carlsbad, Calif.), discard 5.6 ml by placing it in the above-described bleach solution, and then add 5 ml of the antibiotic-antimycotic solution (10,000 units/ml Penicillin G, 10,000 μg/ml Streptomycin, and 25 μg/ml Amphotericin B [Mediatech (Cellgro, Herndon, Va.); 100X]). Add 0.1 ml of the above-described 1M putrescine solution. Add 0.5 ml of a 55 mM 2-mercaptoethanol solution (GIBCO/Invitrogen Corporation, Carlsbad, Calif.). Invert the bottle a few times to mix the solution, and adjust the pH to 7.4 using the above-described sterile 5M sodium hydroxide and/or sterile 5M hydrochloric acid.

DD. SFD-PPELSC-HC-Release Solution B

Under sterile conditions, take a fresh 500 ml bottle of Dulbecco's phosphate buffered saline (DPBS) with calcium and magnesium, discard 0.6 ml by placing it in the above-described bleach solution, and then add 0.1 ml of the above-described 1M putrescine solution. Add 0.5 ml of a 55 mM 2-mercaptoethanol solution. Invert the bottle a few times to mix the solution, and adjust the pH to 7.4 using the above-described sterile 5M sodium hydroxide and/or sterile 5M hydrochloric acid.

EE. SFD-PPELSC-DP-Release Solution C

Under sterile conditions, take a fresh 500 ml bottle of Dulbecco's phosphate buffered saline (DPBS) without calcium chloride and magnesium chloride (GIBCO/Invitrogen Corporation, Carlsbad, Calif.) and discard 7.8 ml by placing it in the above-described bleach solution. Next, add 5 ml of the preferred antibiotic-antimycotic solution (10,000 units/ml Penicillin G, 10,000 μg/ml Streptomycin, and 25 μg/ml Amphotericin B [Mediatech (Cellgro, Herndon, Va.); 100X]) to the DPBS. Add 0.1 ml of the above-described 1M putrescine solution. Add 0.5 ml of a 55 mM 2-mercaptoethanol solution (GIBCO/Invitrogen Corporation, Carlsbad, Calif.). Then add 2.2 ml of the above-described sterile 0.5M EDTA solution (GIBCO/Invitrogen Corporation, Carlsbad, Calif.). Invert the bottle a few times to mix the solution, and adjust the pH to 7.4 using the above-described sterile 5M sodium hydroxide and/or sterile 5M hydrochloric acid.

FF. SFD-PPELSC-HC-Release Solution C

Under sterile conditions, take a fresh 500 ml bottle of Dulbecco's phosphate buffered saline (DPBS) without calcium chloride and magnesium chloride and discard 2.8 ml by placing it in the above-described bleach solution. Add 0.1 ml of the above-described 1M putrescine solution. Add 0.5 ml of a 55 mM 2-mercaptoethanol solution. Then add 2.2 ml of the above-described sterile 0.5M EDTA solution. Invert the bottle a few times to mix the solution, and adjust the pH to 7.4 using the above-described sterile 5M sodium hydroxide and/or sterile 5M hydrochloric acid.

GG. SFD-PPELSC-DP-Release Solution D

Carefully weigh out 50 mg of trypsin (DIFCO, Becton-Dickinson Labware, Franklin Lakes, N.J.) and place it in a sterile 500 ml media bottle. Under sterile conditions, add 100 ml of the above-described SFD-PPELSC-DP-Release Solution C solution. Gently swirl the bottle to dissolve the trypsin. Once the trypsin has dissolved, filter sterilize the solution by passing it through a 0.1 μm bottle-top filter (VWR, Bristol, Conn.) into a sterile 500 ml glass media bottle. Use the above-described sterile 5M sodium hydroxide and/or sterile 5M hydrochloric acid to adjust the pH of the solution to 7.4.

HH. SFD-PPELSC-HC-Release Solution D

Carefully weigh out 50 mg of trypsin (DIFCO) and place it in a sterile 500 ml media bottle. Under sterile conditions, add 100 ml of the above-described SFD-PPELSC-HC-Release Solution C solution. Gently swirl the bottle to dissolve the trypsin. Once the trypsin has dissolved, filter sterilize the solution by passing it through a 0.1 μm bottle-top vacuum filter into a sterile 500 ml glass media bottle. Use the above-described sterile 5M sodium hydroxide and/or sterile 5M hydrochloric acid to adjust the pH of the solution to 7.4.

II. SFD-PPELSC-DP-Cryopreservation Medium

Under sterile conditions, take a fresh 500 ml bottle of Opti-MEM I with GLUTAMAX (GIBCO/Invitrogen Corporation, Carlsbad, Calif.). Discard 5.6 ml to bleach, and then add 5 ml of the preferred antibiotic-antimycotic solution (10,000 units/ml Penicillin G, 10,000 μg/ml Streptomycin, and 25 μg/ml Amphotericin B [Mediatech (Cellgro, Herndon, Va.); 100X]). Add 0.1 ml of 1M putrescine solution. Add 0.5 ml of a 55 mM 2-mercaptoethanol solution (GIBCO/Invitrogen Corporation, Carlsbad, Calif.). Add 10 g of bovine serum albumin (BSA) (Sigma, St. Louis, Mo.). Add a sterile stirring bar. Stir the solution on medium speed until the BSA dissolves. Add 0.625 ml of the above-described 8% gelatin solution. Add 37.5 μg fibronectin (Sigma, St. Louis, Mo.). Stir the solution on medium speed until all the components have dissolved. Filter sterilize the solution by passing it through a 0.2 μm bottle-top filter (VWR, Bristol, Conn.) into a sterile 500 ml glass media bottle. Filter sterilize the solution by passing it through a 0.1 μm bottle-top filter (VWR, Bristol, Conn.) into a sterile 500 ml glass media bottle. Use sterile 5M sodium hydroxide and/or sterile 5M hydrochloric acid to adjust the pH of the solution to 7.4. Remove 150 μl per ml medium and add 150 μl per ml 99.999% dimethylsulfoxide (Sigma, St. Louis, Mo.). Swirl gently to mix. Add 5 ng/ml recombinant-human platelet-derived growth factor-BB (Collaborative Biomedical Products, Bedford, Mass.). Swirl the bottle gently to mix the contents.

JJ. SFD-PPELSC-HC-Cryopreservation Medium

Under sterile conditions, take a fresh 500 ml bottle of Opti-MEM I with GLUTAMAX. Discard 0.6 ml to bleach, and then add 0.1 ml of the above-described 1M Putrescine solution. Add 0.5 ml of a 55 mM 2-mercaptoethanol solution. Add 10 g of human serum albumin. Add a sterile stirring bar. Stir the solution on medium speed until the BSA dissolves. Add 0.625 ml of the above-described 8% human type-I collagen solution. Add 37.5 μg fibronectin. Stir the solution on medium speed until all components have dissolved. Filter sterilize the solution by passing it through a 0.2 μm bottle-top filter into a sterile 500 ml glass media bottle. Filter sterilize the solution a second time by passing it through a 0.1 μm bottle-top filter into a sterile 500 ml glass media bottle. Use sterile 5M sodium hydroxide and/or sterile 5M hydrochloric acid to adjust the pH of the solution to 7.4. Remove 150 μl per ml medium and add 150 μl per ml 99.999% dimethylsulfoxide (Sigma, St. Louis, Mo.). Swirl gently to mix. Add 5 ng/ml recombinant-human platelet-derived growth factor-BB (Collaborative Biomedical Products, Bedford, Mass.). Swirl the bottle gently to mix the contents.

The present invention is described above and further illustrated below by way of examples, which are not to be construed in any way as imposing limitations upon the scope of the invention. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### EXAMPLE 1

### Method for Harvesting Animal (Rat) Tissue

The following methods were used to isolate cells from animal tissue. Tissue harvested from a rat hind limb was used as a source for epiblast-like stem cells. (It should be noted that any organ or tissue with a connective tissue component can be utilized as a source for epiblast-like stem cells. However, the exact process for tissue removal will differ depending on the particular organ/tissue harvested.)

The following steps were taken:
1. Put on gloves.
2. Soak wipes with the disinfectant solution.
3. Wipe your gloved hands with the wipes that have been soaked with disinfectant.
4. Weigh an animal, and calculate how much anesthetic agent will be required to anesthetize the animal. Use the appropriate anesthetic agent per 1 kg of body weight.
5. Draw up the appropriate amount of anesthetic agent in a sterile syringe fitted with a 26 gauge needle.
6. Disinfect the injection site with 70% (v/v) ethanol and allow drying by evaporation.
7. Make an intraperitoneal injection through the abdominal wall of the animal.
8. Once the animal is unconscious, disinfect the hind limbs and abdomen with 70% (v/v) ethanol, and allow these areas to dry by evaporation.
9. Shave the hair from the abdomen and hind limbs using an Oster animal shears fitted with a #40 blade.
10. Disinfect the shaved regions using a cotton ball soaked with BETADINE™. Allow the skin to dry by evaporation.
11. Place a sterile #15 blade on a sterile #3 scalpel handle. Make an incision from the xiphoid process to the pubic symphysis.
12. Euthanize the animal by cutting the diaphragm using dissecting scissors (4.5 inch).
13. Immediately following euthanization, make two incisions using a sterile #15 scalpel blade attached to a #3 scalpel handle. Make one incision along the medial surface and one incision along the lateral surface of the thigh and leg. These incisions will aid in the removal of the skin. Remove the skin from each hind limb using the tissue forceps and a scalpel.
14. Cut the quadriceps femoris tendon and the proximal origins of the anterior thigh muscles with the scalpel.
15. Using the tissue forceps, strip the anterior thigh muscles away from the femur.
16. Place the tissue pieces into a 50 ml centrifuge tube.
17. Fill a 50 ml tube with SFD-PPELSC-DP-tissue wash solution, tighten the screw cap, and invert the tube three times.
18. Discard the tissue wash solution to bleach.
19. Repeat steps 17 & 18 until the wash solution is clear (i.e., void of red blood cells).
20. Place the relatively intact anterior thigh muscles into a 50 ml centrifuge tube containing 25 ml of cold (4° C.) SFD-PPELSC-DP-tissue harvest and storage medium.
21. Remove the posterior thigh muscles using a scalpel to cut through the proximal and distal attachments of these muscles.
22. Place the posterior thigh muscles in another 50 ml centrifuge tube containing 25 ml of cold (4° C.) SFD-PPELSC-DP-tissue harvest and storage medium.
23. Place both 50 ml centrifuge tubes on ice until transport.
24. Repeat this procedure on the other hind limb.
25. Transport the tissue on ice to the tissue culture lab.
26. Store the tissue in SFD-PPELSC-DP-tissue harvest and storage medium in the refrigerator at 4° C. (Cells can be harvested anytime post mortem. However, to reduce the number of differentiated cells, progenitor cells, and germ layer lineage stem cells in the cell isolate, store tissue SFD-PPELSC-DP-tissue harvest and storage medium for a minimum of five (5) days).

### EXAMPLE 2

### Method for Harvesting Human Tissue

The following method was used to isolate cells from human adult tissue. Tissue harvested from an adult human was used as a source for epiblast-like stem cells. (It should be noted that any organ or tissue with a connective tissue component can be utilized as a source for human adult stem cells. However, the exact process for tissue removal will differ depending on the particular organ/tissue harvested.)

The following steps were taken:
1. Put on gloves.
2. Soak the wipes with the disinfectant solution.
3. Wipe your gloved hands with the wipes that have been soaked with disinfectant.
4. Disinfect the skin overlying the organ/tissue of choice using a cotton ball soaked with BETADINE™. Allow the area to dry by evaporation.
5. Place a sterile #15 blade on a sterile #3 scalpel handle. Make an incision through the skin.
6. Cut and remove the tissue of choice with the scalpel and tissue forceps.
7. Divide the tissue into pieces approximately 2.54 cm³ (1 inch³) or smaller.
8. Place the tissue pieces into a 50 ml centrifuge tube.
9. Fill 50 ml tube with SFD-PPELSC-(DP or HC)-tissue wash solution, screw cap on lid, and invert three times.
10. Discard the tissue wash solution to bleach.
11. Repeat steps 9 & 10 until the wash solution is clear (i.e., void of red blood cells).
12. Fill the tube with 25 ml of cold (4° C.) SFD-PPELSC-(DP or HC)-tissue harvest and storage medium.
13. Place the 50 ml centrifuge tubes on ice for transport to the tissue culture lab.
14. Store the tissue in SFD-PPELSC-(DP or HC)-tissue harvest and storage medium in the refrigerator at 4° C. (Cells can be harvested anytime post mortem. However, to reduce the number of differentiated cells, progenitor cells, and germ layer lineage stem cells in the cell isolate, store tissue in SFD-PPELSC-(DP or HC)-tissue harvest and storage medium for a minimum of five (5) days).

### EXAMPLE 3

### Methods for Isolation of Animal and Human Stem Cells

The following steps were taken to isolate stem cells using the animal and human tissue harvested in Examples 1 and 2 above.

Cell Isolation of Tissues Weighing 50 Grams or Less:

1. Put on gloves.
2. Soak the wipes with the disinfectant solution.
3. Wipe your gloved hands with wipes that have been soaked in disinfectant.
4. Wipe all the inside surfaces of a class II biosafety cabinet with wipes that have been soaked in disinfectant. Allow the cabinet to dry by evaporation.
5. Wipe the outside counter top with wipes that have been soaked in disinfectant. Allow the countertop to dry by evaporation.
6. Wipe the outside surfaces of all supplies with wipes that have been soaked in disinfectant before placing the supplies in the class II biosafety cabinet.
7. Remove the 50 ml tubes that contain the tissue in SFD-PPELSC-(DP or HC)-tissue harvest and storage medium from the refrigerator.
8. Wipe the outside of the 50 ml tubes with wipes soaked in disinfectant.
9. Place the 50 ml tubes containing the tissue in the class II biosafety cabinet.
10. Pipet 10 ml of fresh sterile SFD-PPELSC-(DP or HC)-tissue harvest and storage medium into sterile 100 mm glass Petri dishes (one dish for each 50 ml tube of tissue).
11. Use sterile forceps to transfer each set of tissues into a separate sterile 100 mm glass Petri dish.
12. Examine the tissue using a dissecting microscope.
13. Use dissecting scissors to cut the tissue into 5 mm³ pieces.
14. Place each 5 mm³ piece of tissue into a sterile 60 mm glass Petri dish containing 10 ml of tissue harvest medium.
15. Carefully mince the muscle tissue using sterile dissecting scissors and very fine pointed sterile forceps. Continue mincing the tissue until it has the consistency of orange marmalade.
16. Take aliquots of approximately 5 ml of the minced tissue and place them in sterile 50 ml centrifuge tubes.
17. Fill tube with wash solution and Vortex each tube to release red blood cells from tissue.
18. Centrifuge the 50 ml centrifuge tubes containing the minced tissue at 100×g for 5 minutes at ambient temperature.
19. Discard the supernatant by placing it in the bleach solution.
20. Repeat steps 17 and 18 until centrifugation supernatant is void of red blood cells.
21. Centrifuge the 50 ml centrifuge tubes containing the minced tissue at 500×g for 5 minutes at ambient temperature.
22. Estimate the volume of each tissue pellet.
23. Resuspend the tissue pellets by raking the centrifuge tubes across an 80-well microtube holder, 12-15 times.
24. Add 7 pellet volumes of the SFD-PPELSC-(DP or HC)-propagation medium and 2 pellet volumes of the SFD-PPELSC-(DP or HC)-cell isolation medium to each tissue suspension.
25. Vortex each tube.
26. Cut a single square of PARAFILM™ and sterilize it by wiping each side with wipes soaked in disinfectant. Allow the PARAFILM™ to dry by evaporation.
27. Fold the PARAFILM™ in half and stretch it. Wrap the double layer of PARAFILM™ around the interface of the cap and the tube of each 50 ml tube and seal it.
28. Place the sealed 50 ml tubes into a sealable container (GLADWARE™).
29. Place the lid on the sealable container (GLADWARE™).
30. Cut a strip of 10 single squares of PARAFILM™ and sterilize it by wiping each side with wipes soaked in disinfectant. Allow the PARAFILM™ to dry by evaporation.
31. Fold the PARAFILM™ in half, stretch it, and wrap it around the interface of the lid and container to seal it.
32. Place the sealed container in a 37° C. shaking water bath and set the shaking speed to low-medium. Alternatively, the sealed container may be placed inside a Brunswick shaker, 37° C. internal temperature, and set the shaking speed to low-medium.
33. Allow the container to shake at 37° C. until the tissue is digested (typically about 10 to 240 minutes). The tissue is digested when no visible tissue clumps remain and the tissue is liquefied.
34. Once the tissue has been completely digested, remove the container from the shaking water bath (or Brunswick shaker). Remove the tubes from the container.
35. Centrifuge the 50 ml centrifuge tubes containing the digested tissue at 500×g for 5 minutes at ambient temperature.
36. Discard the supernatant by placing it in the bleach. Be sure to leave a small amount of the supernatant, about equal the volume of the cell pellet, in the tube. This can be accomplished using one of two methods. The first method involves pouring off the supernatant into the bleach solution. The second method involves aspirating the supernatant using a Pasteur pipet attached to vacuum aspirator. If the second method is chosen, be careful not to dislodge the cell pellet with the Pasteur pipet.
37. Resuspend the cell pellet in the residual supernatant by raking the centrifuge tube longitudinally across an 80-well microtube holder. Repeat this procedure 12-15 times.
38. Reconstitute the cell pellet in 20 ml of SFD-PPELSC-(DP or HC)-plating medium.
   Cell Isolation of Tissues Weighing 50 Grams or More:
1. Put on gloves.
2. Soak the wipes with the disinfectant solution.
3. Wipe your gloved hands with wipes that have been soaked in disinfectant.
4. Wipe all the inside surfaces of a class II biosafety cabinet with wipes that have been soaked in disinfectant. Allow the cabinet to dry by evaporation.
5. Wipe the outside counter top with wipes that have been soaked in disinfectant. Allow the countertop to dry by evaporation.
6. Wipe the outside surfaces of all supplies with wipes that have been soaked in disinfectant before placing the supplies in the class II biosafety cabinet.
7. Remove the 50 ml tubes that contain the tissue in SFD-PPELSC-(DP or HC)-tissue harvest and storage medium from the refrigerator.
8. Wipe the outside of the 50 ml tubes with wipes soaked in disinfectant.
9. Place the 50 ml tubes containing the tissue in the class II biosafety cabinet.
10. Pipet 10 ml of fresh sterile SFD-PPELSC-(DP or HC)-tissue harvest and storage medium into sterile 100 mm glass Petri dishes (one dish for each 50 ml tube of tissue).
11. Use sterile forceps to transfer each set of tissues into a separate sterile 100 mm glass Petri dish.
12. Examine the tissue using a dissecting microscope.
13. Use dissecting scissors to cut the tissue into 5 mm³ pieces.
14. Place each 5 mm³ piece of tissue into a sterile 60 mm glass Petri dish containing 10 ml of tissue harvest medium.
15. Carefully mince the muscle tissue using sterile dissecting scissors and very fine pointed sterile forceps. Continue mincing the tissue until it has the consistency of orange marmalade.
16. Take aliquots of approximately 5 ml of the minced tissue and place them in sterile 50 ml centrifuge tubes.
17. Fill tube with wash solution and Vortex each tube to release red blood cells from tissue.
18. Centrifuge the 50 ml centrifuge tubes containing the minced tissue at 100×g for 5 minutes at ambient temperature.
19. Discard the supernatant by placing it in the bleach solution.
20. Repeat steps 17 and 18 until centrifugation supernatant is void of red blood cells.
21. Centrifuge the 50 ml centrifuge tubes containing the minced tissue at 500×g for 5 minutes at ambient temperature.
22. Estimate the volume of each tissue pellet.
23. Resuspend the tissue pellets by raking the centrifuge tubes across an 80-well microtube holder, 12-15 times.
24. Reconstitute resuspended cell pellets in one pellet volume of SFD-PPELSC-(DP or HC)-cell isolation medium to each tissue suspension.
25. Transfer reconstituted cell suspensions to a single tissue culture bottle (volume of bottle should be a minimum of 10× the volume of the combined cell pellets).
26. Add 7 pellet volumes of the SFD-PPELSC-(DP or HC)-propagation medium and 1 pellet volume of the SFD-PPELSC-(DP or HC)-cell isolation medium to the cell suspension.
27. Vortex each tube.
28. Add a sterilized stir bar to bottle containing cell suspension.
29. Cut a single square of PARAFILM™ and sterilize it by wiping each side with wipes soaked in disinfectant. Allow the PARAFILM™ to dry by evaporation.
30. Fold the PARAFILM™ in half and stretch it. Wrap the double layer of PARAFILM™ around the interface of the cap and the bottle.
28. Place the sealed container in a 37° C. shaking water bath and set the shaking speed to low-medium. Alternatively, the sealed container may be placed inside a Brunswick shaker, 37° C. internal temperature, and set the shaking speed to low-medium. Alternatively, the sealed container may be placed on a stirring platform inside a 37° C. incubator or oven.
29. Allow the container to shake at 37° C. until the tissue is digested (typically about 10 to 240 minutes). The tissue is digested when no visible tissue clumps remain and the tissue is liquefied.
30. Once the tissue has been completely digested, remove the container from the shaking water bath (or Brunswick shaker).
31. Aliquot the digested tissue into 50 ml centrifuge tubes.
32. Centrifuge the 50 ml centrifuge tubes containing the digested tissue at 500×g for 5 minutes at ambient temperature.
33. Discard the supernatant by placing it in the bleach. Be sure to leave a small amount of the supernatant, about equal the volume of the cell pellet, in the tube. This can be accomplished using one of two methods. The first method involves pouring off the supernatant into the bleach solution. The second method involves aspirating the supernatant using a Pasteur pipet attached to vacuum aspirator. If the second method is chosen, be careful not to dislodge the cell pellet with the Pasteur pipet.
34. Resuspend the cell pellet in the residual supernatant by raking the centrifuge tube longitudinally across an 80-well microtube holder. Repeat this procedure 12-15 times.
35. Reconstitute the cell pellet in 20 ml of SFD-PPELSC-(DP or HC)-plating medium.
   Cell Media Filtration:
1. Set up a sterile 90 μm Nitex fabric filter (Sefar America,Inc., Burnsville, Minn.) apparatus on top of a sterile 100 ml glass media bottle.
2. Pre-wet the 90 μm Nitex filter with proliferation medium. To accomplish this step, place 10 ml of SFD-PPELSC-(DP or HC)-plating medium into the barrel of the 50 ml syringe (Fisher Scientific, Pittsburgh). Allow the medium to percolate by gravity through the filter to saturate the membrane. The membrane is saturated when a few drops of medium appear in the bottle. If drops do not appear in the bottle, repeat the wetting procedure until drops appear within the bottle.
3. Place the cell suspension into the 50 cc syringe tube and allow it to flow by gravity through the filter.
4. Once the cell suspension has completely passed through the filter, wash the 90 μm filter apparatus with 10 ml of the fresh SFD-PPELSC-(DP or HC)-plating medium.
5. Remove the 100 ml media bottle from the 90 μm filter apparatus and cap the bottle.
6. Remove the 90 μm Nitex filter from the unit and place it into a 50 ml tube containing 10 ml of SFD-PPELSC-(DP or HC)-plating medium.
7. Vortex the centrifuge tube on medium speed for 3 pulses at about 1 second each to release the cells.
8. Place the cell suspension into a 75 cm² flask (BD Biosciences-Discovery, Labware, Bedford, Mass.).
9. Label the flask using a permanent marker.
10. Rock the tissue culture flask from side to side to disperse the cell suspension.
11. Place the flask into a humidified incubator that uses an environment of 95% air/5% carbon dioxide and is set at 37° C.
12. Set up a 20 μm Nitex fabric filter (Sefar America, Inc., Burnsville, Minn.) apparatus on top of a clean sterile 100 ml glass media bottle.
13. Pre-wet the Nitex filter with SFD-PPELSC-(DP or HC)-plating medium, as described in step 2 above.
14. Take the cell suspension that has been filtered through the 90 μm filter and place it into the 50 cc syringe tube for the 20 μm Nitex filter. Allow the suspension to pass by gravity through the filter.
15. Wash the 20 μm filter apparatus with 10 ml of fresh SFD-PPELSC-(DP or HC)-plating medium.
16. Remove the 100 ml media bottle from the 20 μm filter apparatus and cap it.
17. Remove the 20 μm filter from the unit and place it into a 50 ml tube containing 10 ml of SFD-PPELSC-(DP or HC)-plating medium.
18. Vortex the centrifuge tube at medium speed for 3 pulses of 1 second each to release the cells.
19. Place the cell suspension into a 75 cm² flask (BD Biosciences-Discovery, Labware, Bedford, Mass.).
20. Label the flask using a permanent marker.
21. Rock the tissue culture flask from side to side to disperse the cell suspension.
22. Place the flask into a humidified incubator that uses an environment of 95% air/5% carbon dioxide and is set at 37° C.
23. Divide the sieved cell suspension into equal volumes and place in sterile 15 ml centrifuge tubes.
24. Centrifuge the sieved cell suspension at 500×g for 5 minutes at ambient temperature.
25. After centrifugation, discard the supernatant from all centrifuge tubes by placing it in bleach solution. Be sure to leave a small amount of the supernatant, about equal to the volume of the cell pellet.
26. Resuspend the cell pellets by raking the centrifuge tubes across an 80-well microtube holder, 12-15 times.
27. Using a 5 ml pipet and starting with 5 ml of SFD-PPELSC-(DP or HC)-plating medium, wash and triturate each 15 ml centrifuge tube in sequence. Combine the cell suspensions.
28. Place the combined cell suspension into a 15 ml conical tube.
29. Using a 10 ml pipet and starting with 5 ml of SFD-PPELSC-(DP or HC)-plating medium, rewash and triturate each 15 ml centrifuge tube in sequence. Combine the rewashes.
30. Add the rewash to the cell suspension in the 15 ml tube. Triturate the cell suspension gently, 10-12 times.
   Cell Counting:
1. Measure and record the total volume of the combined cell suspension.
2. Remove 0.1 ml of the cell suspension, and place it into a 1.7 ml microcentrifuge tube.
3. Add 0.1 ml of 0.4% trypan blue solution to the 0.1 ml of the cell suspension and triturate 6-8 times gently to mix the resulting solution.
4. Remove 100 μl of the trypan blue/cell mixture, load the hemocytometer, and examine under a light microscope with a 10× objective. An alternative method is to place the trypan blue/cell mixture in a Coulter counter to count the cells.
5. Determine the number of viable cells for plating. Cell viability is determined by trypan blue exclusion. Calculate the number of viable cells per ml of cell suspension by first counting the total number of viable (clear/refractile) cells present in a volume of the cell suspension. This is accomplished by counting all the cells present in the nine large grids on the hemocytometer. Dead cells are blue in color.
6. Calculate the average number of cells for each large grid using the formula: [(A1+A2+A3+A4+A5+A6+A7+A8+A9)/9=avg. cell number].
7. Calculate the number of viable cells per ml of cell suspension, using the formula: [(avg. cell number)/5)/5)×0.25)×2]=cells×10⁶ per ml.
8. Determine the total number of cells by multiplying the volume of the cell suspension by the number of cells×10⁶ per ml.
   Cell Plating:
1. The initial cell densities were found to be 0.5 to 0.75×10⁶ cells per 5 ml of SFD-PPELSC-(DP or HC)-plating medium for 25 cm² flasks (BD Biosciences-Discovery, Labware, Bedford, Mass.) and 1.0 to 1.5×10⁶ cells per 10 ml of SFD-PPELSC-(DP or HC)-plating medium for 75 cm² flasks (BD Biosciences-Discovery, Labware, Bedford, Mass.).
2. To plate the cells, first determine the volume of cell suspension needed to yield the required number of cells for plating. Next subtract the volume of the cell suspension from the flask cell volume (5 ml for 25 cm² flasks and 10 ml for 75 cm² flasks), using the formula: [(flask volume −cell suspension volume)=residual volume].
3. Pre-wet the flask surface to disperse surface tension with the residual volume of SFD-PPELSC-(DP or HC)-plating medium. Rock the flask back and forth and side to side so that the surface of the flask is completely covered.
4. Add the cell suspension volume to the flask. Evenly distribute the cells across the surface of the flask by rocking the flask back and forth and side to side.
5. Label the flasks using a permanent marker.
6. Place the flask(s) into a humidified incubator that uses an environment of 95% air/5% carbon dioxide and is set at 37° C.
   Cell Cultivating:
1. After initial plating, the cells must be observed daily until after the first passage and cared for appropriately depending on the results of visual observations of the cultures. For example, the adult stem cells will attach to the flask surface within 18-24 hours after plating. In the initial plating medium after attachment there will be many types of floating cells, damaged cells, lysed cells, cell debris, intracellular enzymes, intracellular organelles, etc. This cellular debris must be removed from the culture to ensure the subsequent viability of the attached cells.
2. Allow the cells a minimum of 18-24 hours to attach to the surface of the flask.
3. Put on gloves.
4. Soak the wipes with disinfectant solution.
5. Wipe the gloved hands with wipes soaked in disinfectant.
6. Wipe all the inside surfaces of a class II biosafety cabinet with wipes that have been soaked with disinfectant. Allow the cabinet to dry by evaporation.
7. Wipe the outside counter top with wipes that have been soaked with disinfectant. Allow it to dry by evaporation.
8. Wipe the outside surfaces of all supplies with wipes that have been soaked with disinfectant before placing the supplies into the class II biosafety cabinet.
9. Twenty-four hours after cell plating, discard the plating medium by placing it in the bleach solution. This can be accomplished either by pouring the medium into the bleach solution or by aspirating the medium into bleach solution using a vacuum aspirator and a Pasteur pipet.
10. Wash the culture flask twice with 10 ml of SFD-PPELSC-(DP or HC)-cell wash. Discard the wash solutions by placing them in the bleach solution. Use a gentle rocking motion to loosen any attached cellular debris during the wash steps. Use the phase contrast microscope to visually inspect the flasks to ensure the removal of cellular debris. A number of consecutive washes may be required to remove the debris from the cultures
11. Feed the culture with fresh SFD-PPELSC-(DP or HC)-propagation medium and return it to the incubator.
12. Replace the SFD-PPELSC-(DP or HC)-propagation medium in the cultures every 24-48 hours, depending on the percentage of confluence of the cells within the flask(s). (For example, when the confluence of the cells is less than 70%, feed the culture(s) with 5 ml (per 25 cm² flask) or 10 ml (per 75 cm² flask) of medium. When cell confluence is 80-90%, feed the culture(s) with 10-15 ml (per 25 cm² flask) or 20-30 ml (per 75 cm² flask) of medium. Once the cultures reach 100% confluence, fill the flasks to the neck with SFD-PPELSC-(DP or HC)-propagation medium. Stand the flasks up on end in the incubator. Be sure not to fill the flasks up to the cap. Leave the neck empty to ensure that proper gas exchange occurs in the flask.)
   Cell Release From Flask Surface:

Pluripotent epiblast-like stem cells are not contact inhibited. Therefore, the cells continue to proliferate, forming multiple confluent layers of cells as long as the cells are maintained within proliferation medium.

Once multiple confluent layers of the cells are present, the cells are released from the surface of the flask using the following steps:
1. Put on gloves.
2. Soak the wipes with disinfectant solution.
3. Wipe the gloved hands with wipes that have been soaked in disinfectant.
4. Wipe all the inside surfaces of a class II biosafety cabinet with wipes that have been soaked with disinfectant. Allow the cabinet to dry by evaporation.
5. Wipe the outside of the counter top with wipes that have been soaked with disinfectant. Allow the counter top to dry by evaporation.
6. Wipe the outside surfaces of all supplies with wipes that have been soaked with disinfectant before placing the supplies into a class II biosafety cabinet.
7. Under sterile conditions, add 2 ml of SFD-PPELSC-(DP or HC)-release solution-A to a 15 ml centrifuge tube. Repeat this for each flask of cells that will be released.
8. Discard the propagation medium from the culture flask by placing it into the bleach solution.
9. Wash the culture flask with SFD-PPELSC-(DP or HC)-release solution-B: 13 ml for the 25 cm² flask and 35 ml for the 75 cm² flask.
10. Wait a minimum of 5 minutes and then discard the release solution by placing it in the bleach solution. Repeat this washing procedure with SFD-PPELSC-(DP or HC)-release solution-B one more time.
11. Wash the culture flask with SFD-PPELSC-(DP or HC)-release solution-C: 10 ml for the 25 cm² flask and 25 ml for the 75 cm² flask.
12. Wait a minimum of 5 minutes and discard the SFD-PPELSC-(DP or HC)-release solution-C by placing it in the bleach solution.
13. Add 4 ml of SFD-PPELSC-(DP or HC)-release solution-D to the flask to remove the cells from the surface of the flask. The cells will lift off in 2-3 minutes. Gently rock the culture flask side to side to enhance the release process.
14. Once the cells have been released from the flask surface, use a 5 ml pipet to triturate the cells into suspension. Wash the flask surface with the cell suspension.
15. Remove the cell suspension from the flask and place it into a 15 ml tube containing the SFD-PPELSC-(DP or HC)-release solution-A.
16. Visually inspect the flasks to make sure that the cells have been released from the surface of the flask.
17. Wash the flasks with 2 ml of SFD-PPELSC-(DP or HC)-propagation medium to ensure that more than 99% of the cells have been released from the surface of the flask. Add the wash solutions to 15 ml tubes that contain the SFD-PPELSC-(DP or HC)-release solution-A.
18. Fill the 15 ml centrifuge tube containing the cell suspension to the 14 ml mark with SFD-PPELSC-(DP or HC)-propagation medium. Gently invert the tube twice to mix the contents.
19. Centrifuge the tube at 500×g for 5 minutes at ambient temperature.
20. After centrifugation, discard the supernatant from the centrifuge tube by placing it in the bleach solution. Be sure to leave a small amount of the supernatant, about equal the volume of the cell pellet.
21. Resuspend the cell pellet by raking the centrifuge tubes across an 80-well microtube holder. Repeat this process 12-15 times.
22. Use a 5 ml pipet to wash and triturate each 15 ml centrifuge tube in sequence. Use 1-5 ml of SFD-PPELSC-(DP or HC)-propagation medium in this process. The volume to be used will depend upon the volume of the cell suspension to be resuspended.
23. Place the combined cell suspension into a 15 ml tube.
24. Count the cells as outlines in the “Cell Counting” section above.
   Cryopreservation of Pluripotent Epiblast-like Stem Cells:

The pluripotent epiblast-like stem cells were cryopreserved by slow freezing and storage at −80° C. using the following protocol.
1. Put on gloves.
2. Soak the wipes with disinfectant solution.
3. Wipe the gloved hands with wipes that have been soaked in disinfectant.
4. Wipe all inside surfaces of a class II biosafety cabinet with wipes that have been soaked in disinfectant. Allow the cabinet to dry by evaporation.
5. Wipe the outside counter top with wipes that have been soaked in disinfectant. Allow the counter top to dry by evaporation.
6. Wipe the outside surfaces of all supplies with wipes that have been soaked in disinfectant before placing the supplies into the class II biosafety cabinet.
7. Determine the number of cryovials to be used, based on the cell counts. The optimum range of final cell density for cryopreservation is 1 to 11×10⁶ cells per ml.
8. Label the cryovials. Wipe the outside of the vials with wipes that have been soaked with disinfectant.
9. Place the cryovials on an 80-well microtube holder.
10. Pipet 500 μl of 2× cellular suspension into each cryovial. For example, if the final concentration is 2.5×10⁶ cells per ml of medium, concentrate the cells to 5×10⁶ cells per ml. Then place 500 μl of cellular suspension into each cryovial.
11. Use a 1000 μl pipettor with a 1000 μl sterile filtered tip to add 500 μl of SFD-PPELSC-(DP or HC)-cryopreservation medium to each cryovial.
12. Tighten the caps of the cryovials.
13. Gently invert the cryovials twice to mix their contents.
14. Gently place the cryovials into a freezing chamber containing 100% isopropyl alcohol.
15. Place the freezing chamber into a −80° C. freezer.
16. Allow freezing and storage of the cells for a minimum of 36-48 hours before thawing and plating the cells.
   Thawing the Frozen Cells for Plating:
1. Put on gloves.
2. Soak the wipes with disinfectant solution.
3. Wipe the gloved hands with wipes that have been soaked in disinfectant.
4. Wipe all the inside surfaces of a class II biosafety cabinet with wipes that have been soaked in disinfectant. Allow the cabinet to dry by evaporation.
5. Wipe the outside counter top with wipes that have been soaked in disinfectant. Allow the counter top to dry by evaporation.
6. Wipe the outside surfaces of all supplies with wipes that have been soaked in disinfectant before placing the supplies into the class II biosafety cabinet.
7. Determine the number of cryovials of frozen cells to be used, based on the composition of the cellular constituents and the cell counts. Use one 15 ml tube per cryovial.
8. Pipet 13 ml of SFD-PPELSC-(DP or HC)-propagation medium at ambient temperature into each 15 ml tube.
9. Remove the cryovials from the freezer.
10. Flash-thaw the frozen cellular suspension in the cryovials. The frozen medium is yellow in color, and the thawed medium is salmon in color.
11. Remove the thawed cellular suspension gently using a 1 ml pipet.
12. Add the cellular suspension drop-wise to a 15 ml tube containing 13 ml of SFD-PPELSC-(DP or HC)-propagation medium.
13. Tighten the screw cap.
14. Gently invert the tube twice to mix its contents.
15. Centrifuge the tube at 500×g for 5 minutes at ambient temperature.
16. After centrifugation, discard the supernatant from the centrifuge tube by placing it in the bleach solution. Be sure to leave a small amount of the supernatant, about equal to the volume of the cellular pellet.
17. Resuspend the cellular pellet by raking the centrifuge tube across an 80-well microtube holder. Repeat this process 12-15 times.
18. Using a 5 ml pipet and starting with 2 ml of SFD-PPELSC-(DP or HC)-propagation medium, wash and triturate each 15 ml centrifuge tube in sequence, and combine the cellular suspensions.
19. Place the combined cell suspension into a 15 ml tube.
20. Count the cells according to the “Cell Counting” section above.
21. Plate the cells according to the “Cell Plating” section above.
22. Cultivate the cells according to the “Cell Cultivating” section above.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A serum-free solution suitable for washing tissue prior to tissue harvest of postnatal pluripotent epiblast-like stem cells, said solution comprising:
a filter sterilized buffer solution comprising:
(i) Dulbecco's phosphate buffered saline containing calcium chloride and magnesium chloride;
(ii) albumin;
(iii) 2-mercaptoethanol;
(iv) a putrescine-containing solution;
(v) an antibiotic-antimycotic solution;
(vi) an amount of sterile sodium hydroxide or sterile hydrochloric acid to provide a filter sterilized buffer solution having a pH of 7.4.

2. The serum-free solution of claim 1, wherein Dulbecco's phosphate buffered saline containing calcium chloride and magnesium chloride comprises a buffered saline solution containing:

| Component | Grams Per Liter (g/L) |
|---|---|
| CaCl₂.2H₂O | 0.133 |
| MgCl₂.6H₂O | 0.1 |
| KCl | 0.2 |
| KH₂PO₄ (anhydride) | 0.2 |
| NaCl | 8.0 |
| Na₂HPO₄ (anhydride) | 1.15 |

3. The serum-free solution of claim 1, wherein the antibiotic-antimycotic solution comprises penicillin, streptomycin, and fungizone-B.

4. The serum-free solution of claim 3, wherein the antibiotic-antimycotic solution comprises 10,000 units/ml Penicillin G, 10,000 μg/ml Streptomycin, and 25 μg/ml Amphotericin B.

5. The serum-free solution of claim 1, wherein the putrescine-containing solution comprises a filter sterilized solution containing:
putrescine;
cell culture media; and
an optional amount of sterile sodium hydroxide or sterile hydrochloric acid to provide a putrescine-containing solution having a pH of 7.4.

6. The serum-free solution of claim 5, wherein the cell culture media comprises a modification of Eagle's Minimal Essential Medium buffered with HEPES and sodium bicarbonate, and supplemented with hypoxanthine, thymidine, sodium pyruvate, GLUTAMAX, trace elements and growth factors.

7. The serum-free solution of claim 1, wherein the serum-free solution comprises:
(a) greater than about 90 percent by weight of the filter sterilized buffer solution, wherein the filter sterilized buffer solution comprises:
(i) greater than about 90 percent by weight Dulbecco's phosphate buffered saline containing calcium chloride and magnesium chloride;
(ii) up to about 5.0 percent by weight albumin;
(iii) greater than 0 up to about 6.0 percent by weight of an antibiotic-antimycotic solution containing penicillin, streptomycin, and fungizone-B;
(iv) greater than 0 up to about 1.0 percent by weight of the putrescine-containing solution;
(v) greater than 0 up to about 1.0 percent by weight of 2-mercaptoethanol; and
(vi) an amount of sterile sodium hydroxide or sterile hydrochloric acid to provide a filter sterilized buffer solution having a pH of 7.4.

8. The serum-free solution of claim 1, wherein the serum-free solution comprises:
(a) 486 ml of the filter sterilized buffer solution, wherein the filter sterilized buffer solution comprises:
(i) Dulbecco's phosphate buffered saline containing calcium chloride and magnesium chloride;
(ii) 0.5 percent by weight of albumin;
(iii) 15 ml of an antibiotic-antimycotic solution comprising 10,000 units/ml Penicillin G, 10,000 μg/ml Streptomycin, and 25 μg/ml Amphotericin B;
(iv) 0.1 ml of a 1M putrescine solution comprising:
(i) 1.61 g of putrescine;
(ii) 10 ml of OPTI-MEM I with GLUTAMAX;
(v) 0.9 ml of a 55 mM 2-mercaptoethanol solution;
(vi) an amount of sterile sodium hydroxide or sterile hydrochloric acid to provide a filter sterilized buffer solution having a pH of 7.4.

9. A serum-free solution for postnatal pluripotent epiblast-like stem cells, said solution comprising:
(a) a cell culture solution comprising Eagle's Minimal Essential Medium buffered with HEPES and sodium bicarbonate, and supplemented with hypoxanthine, thymidine, sodium pyruvate, and growth factors;
(b) an optional antibiotic-antimycotic solution;
(c) putrescine;
(d) 2-mercaptoethanol;
(e) albumin; and
(f) an optional amount of sterile sodium hydroxide or sterile hydrochloric acid to provide a serum-free solution having a pH of 7.4.

10. The serum-free solution of claim 9, wherein the antibiotic-antimycotic solution comprises penicillin, streptomycin, and fungizone-B.

11. The serum-free solution of claim 10, wherein the antibiotic-antimycotic solution comprises 10,000 units/ml Penicillin G, 10,000 μg/ml Streptomycin, and 25 μg/ml Amphotericin B.

12. The serum-free solution of claim 9, further comprising:
(g) type-I collagen.

13. The serum-free solution of claim 12, wherein the serum-free solution is suitable for use as a tissue harvest and storage medium and comprises:
(a) greater than 90 percent by weight of the cell culture solution;
(b) greater than 0 up to about 6.0 percent by weight of an antibiotic-antimycotic solution comprising penicillin, streptomycin, and fungizone-B;
(c) greater than 0 up to about 1.0 percent by weight of the putrescine;
(d) greater than 0 up to about 1.0 percent by weight of the 2-mercaptoethanol;
(e) greater than 0 up to about 10.0 percent by weight of the albumin;
(f) greater than 0 up to about 1.0 percent by weight of type-I collagen; and
(g) an optional amount of sterile sodium hydroxide or sterile hydrochloric acid to provide a serum-free solution having a pH of 7.4.

14. The serum-free solution of claim 13, wherein the serum-free solution is suitable for use as a tissue harvest and storage medium and comprises:
(a) 484.4 ml of the cell culture solution;
(b) 15.0 ml of an antibiotic-antimycotic solution comprising 10,000 units/ml Penicillin G, 10,000 μg/ml Streptomycin, and 25 μg/ml Amphotericin B;
(c) 0.05 mg of putrescine;
(d) 0.5 ml of a 55 mM 2-mercaptoethanol solution;
(e) 5.0 g of bovine serum albumin;
(f) 50 mg of type-I collagen; and
(g) an optional amount of sterile sodium hydroxide or sterile hydrochloric acid to provide a serum-free solution having a pH of 7.4.

15. The serum-free solution of claim 13, wherein the serum-free solution is suitable for use as a tissue harvest and storage medium and comprises:
(a) 484.4 ml of the cell culture solution;
(b) 5.0 ml of an antibiotic-antimycotic solution comprising 10,000 units/ml Penicillin G, 10,000 μg/ml Streptomycin, and 25 μg/ml Amphotericin B;
(c) 0.05 mg of putrescine;
(d) 0.5 ml of a 55 mM 2-mercaptoethanol solution;
(e) 5.0 g of human serum albumin;
(f) 50 mg of human type-I collagen;
(g) an optional amount of sterile sodium hydroxide or sterile hydrochloric acid to provide a serum-free solution having a pH of 7.4.

16. A cell isolation medium comprising a filter sterilized solution comprising:
(a) the serum-free solution of claim 9;
(b) type-I collagenase; and
(c) dispase.

17. The cell isolation medium of claim 16, wherein the medium contains:
up to about 500 units of type-I collagenase per ml of solution; and
up to about 70 units of dispase per ml of solution.

18. The cell isolation medium of claim 16, wherein the medium comprises:
(a) greater than 90 percent by weight of the cell culture solution;
(b) greater than 0 up to about 2.0 percent by weight of the optional antibiotic-antimycotic solution;
(c) greater than 0 up to about 1.0 percent by weight of putrescine;
(d) greater than 0 up to about 1.0 percent by weight of 2-mercaptoethanol;
(e) greater than 0 up to about 3.0 percent by weight of albumin;
(f) up to about 500 units of type-I collagenase per ml of medium;
(g) up to about 70 units of dispase per ml of medium; and
(h) an optional amount of sterile sodium hydroxide or sterile hydrochloric acid to provide a serum-free solution having a pH of 7.4.

19. The cell isolation medium of claim 16, wherein the medium comprises:
(a) 484.4 ml of the cell culture solution;
(b) 5.0 ml of an antibiotic-antimycotic solution comprising 10,000 units/ml Penicillin G, 10,000 μg/ml Streptomycin, and 25 μg/ml Amphotericin B;
(c) 0.05 mg of putrescine;
(d) 0.5 ml of a 55 mM 2-mercaptoethanol solution;
(e) 5.0 g of human serum albumin;
(f) 250 units of type-I collagenase per ml of medium;
(g) 33.3 units of dispase per ml of medium; and
(h) an optional amount of sterile sodium hydroxide or sterile hydrochloric acid to provide a serum-free solution having a pH of 7.4.

20. The serum-free solution of claim 12, wherein the solution is suitable as a plating medium or a propagation medium, and further comprises:
(g) fibronectin; and
(h) platelet-derived growth factor-BB per ml of serum-free solution.

21. The serum-free solution of claim 20, wherein the serum-free solution comprises:
(a) greater than 90 percent by weight of the cell culture solution;
(b) greater than 0 up to about 6.0 percent by weight of an antibiotic-antimycotic solution containing penicillin, streptomycin, and fungizone-B;
(c) greater than 0 up to about 1.0 percent by weight of the putrescine;
(d) greater than 0 up to about 1.0 percent by weight of the 2-mercaptoethanol;
(e) greater than 0 up to about 10.0 percent by weight of the albumin;
(f) greater than 0 up to about 1.0 percent by weight of type-I collagen;
(g) greater than 0 up to about 1.0 percent by weight of the fibronectin; and
(h) an optional amount of sterile sodium hydroxide or sterile hydrochloric acid to provide a serum-free solution having a pH of 7.4.

22. The serum-free solution of claim 20, wherein the serum-free solution is suitable as a plating medium and comprises:
(a) 494.4 ml of the cell culture solution;
(b) 5.0 ml of an antibiotic-antimycotic solution comprising 10,000 units/ml Penicillin G, 10,000 μg/ml Streptomycin, and 25 μg/ml Amphotericin B;
(c) 0.05 mg of putrescine;
(d) 0.5 ml of a 55 mM 2-mercaptoethanol solution;
(e) 10.0 g of bovine serum albumin;
(f) 5.0 g of human type-I collagen;
(g) 37.5 μg of fibronectin;
(h) an optional amount of sterile sodium hydroxide or sterile hydrochloric acid to provide a serum-free solution having a pH of 7.4; and
(i) about 5.0 ng of recombinant-human platelet-derived growth factor-BB per ml of serum-free solution.

23. The serum-free solution of claim 20, wherein the serum-free solution is suitable as a plating medium and comprises:
(a) 499.4 ml of the cell culture solution;
(b) 0.05 mg of putrescine;
(c) 0.5 ml of a 55 mM 2-mercaptoethanol solution;
(d) 5.0 g of albumin;
(e) 5.0 g of type-I collagen;
(f) 37.5 μg of fibronectin;
(g) 5.0 ng/ml platelet-derived growth factor-BB; and
(h) an optional amount of sterile sodium hydroxide or sterile hydrochloric acid to provide a serum-free solution having a pH of 7.4.

24. The serum-free solution of claim 9, wherein the serum-free solution is suitable for use as a cell wash medium, and the cell culture solution further comprises L-glutamine.

25. The serum-free solution of claim 24, wherein the solution comprises:
(a) greater than 90 percent by weight of the cell culture solution;
(b) greater than 0 up to about 2.0 percent by weight of an optional antibiotic-antimycotic solution;
(c) greater than 0 up to about 1.0 percent by weight of putrescine;
(d) greater than 0 up to about 1.0 percent by weight of 2-mercaptoethanol;
(e) greater than 0 up to about 10.0 percent by weight of albumin; and
(f) an optional amount of sterile sodium hydroxide or sterile hydrochloric acid to provide a serum-free solution having a pH of 7.4.

26. The serum-free solution of claim 24, wherein the solution comprises:
(a) 494.4 ml of the cell culture solution;
(b) 5.0 ml of an antibiotic-antimycotic solution comprising 10,000 units/ml Penicillin G, 10,000 μg/ml Streptomycin, and 25 μg/ml Amphotericin B;
(c) 0.05 mg of putrescine;
(d) 0.5 ml of a 55 mM 2-mercaptoethanol solution;
(e) 1.0 g of bovine serum albumin; and
(f) an optional amount of sterile sodium hydroxide or sterile hydrochloric acid to provide a serum-free solution having a pH of 7.4.

27. The serum-free solution of claim 24, wherein the solution comprises:
(a) 499.4 ml of the cell culture solution;
(b) 0.05 mg of putrescine;
(c) 0.5 ml of a 55 mM 2-mercaptoethanol solution;
(d) 1.0 g of human serum albumin; and
(e) an optional amount of sterile sodium hydroxide or sterile hydrochloric acid to provide a serum-free solution having a pH of 7.4.

28. The serum-free solution of claim 20, wherein the serum-free solution is suitable as a propagation medium and comprises:
(a) 494.4 ml of the cell culture solution;
(b) 5.0 ml of an antibiotic-antimycotic solution comprising 10,000 units/ml Penicillin G, 10,000 μg/ml Streptomycin, and 25 μg/ml Amphotericin B;
(c) 0.05 mg of putrescine;
(d) 0.5 ml of a 55 mM 2-mercaptoethanol solution;
(e) 1.0 g of albumin;
(f) 50 mg of type-I collagen;
(g) 37.5 μg of fibronectin;
(h) 10.0 ng/ml platelet-derived growth factor-BB; and
(i) an optional amount of sterile sodium hydroxide or sterile hydrochloric acid to provide a serum-free solution having a pH of 7.4.

29. The serum-free solution of claim 20, wherein the serum-free solution is suitable as a propagation medium and comprises:
(a) 499.4 ml of the cell culture solution;
(b) 0.05 mg of putrescine;
(c) 0.5 ml of a 55 mM 2-mercaptoethanol solution;
(d) 1.0 g of albumin;
(e) 50 mg of type-I collagen;
(f) 37.5 μg of fibronectin;
(g) 10.0 ng/ml platelet-derived growth factor-BB; and
(h) an optional amount of sterile sodium hydroxide or sterile hydrochloric acid to provide a serum-free solution having a pH of 7.4.

30. The serum-free solution of claim 20, wherein the serum-free solution is suitable as a cryopreservation medium and further comprises:
(i) dimethyl sulfoxide.

31. The serum-free solution of claim 30, wherein the serum-free solution comprises:
(a) greater than 90 percent by weight of the cell culture solution;
(b) greater than 0 up to about 2.0 percent by weight of an antibiotic-antimycotic solution comprising penicillin, streptomycin, and fungizone-B;
(c) greater than 0 up to about 1.0 percent by weight of putrescine;
(d) greater than 0 up to about 1.0 percent by weight of 2-mercaptoethanol;
(e) greater than 0 up to about 20.0 percent by weight of albumin;
(f) greater than 0 up to about 1.0 percent by weight of type-I collagen;
(g) greater than 0 up to about 1.0 percent by weight of the fibronectin;
(h) greater than 0 up to about 20.0 ng/ml platelet-derived growth factor-BB;
(i) greater than 0 up to about 500 μl/ml dimethylsulfoxide; and
(j) an optional amount of sterile sodium hydroxide or sterile hydrochloric acid to provide a serum-free solution having a pH of 7.4.

32. The serum-free solution of claim 30, wherein the serum-free solution comprises:
(a) 494.25 ml of the cell culture solution;
(b) 5.0 ml of an antibiotic-antimycotic solution comprising 10,000 units/ml Penicillin G, 10,000 μg/ml Streptomycin, and 25 μg/ml Amphotericin B;
(c) 0.05 mg of putrescine;
(d) 0.5 ml of a 55 mM 2-mercaptoethanol solution;
(e) 1.0 g of albumin;
(f) 50 mg of type-I collagen;
(g) 37.5 μg of fibronectin;
(h) 5.0 ng/ml platelet-derived growth factor-BB;
(i) 150 μl/ml of 99.999% pure dimethyl sulfoxide; and
(j) an optional amount of sterile sodium hydroxide or sterile hydrochloric acid to provide a serum-free solution having a pH of 7.4.

33. The serum-free solution of claim 30, wherein the serum-free solution comprises:
(a) 499.25 ml of the cell culture solution;
(b) 0.05 mg of putrescine;
(c) 0.5 ml of a 55 mM 2-mercaptoethanol solution;
(d) 1.0 g of albumin;
(e) 50 mg of type-I collagen;
(f) 37.5 μg of fibronectin;
(g) 5.0 ng/ml platelet-derived growth factor-BB;
(h) 150 μl/ml of 99.999% pure dimethyl sulfoxide; and
(i) an optional amount of sterile sodium hydroxide or sterile hydrochloric acid to provide a serum-free solution having a pH of 7.4.

34. The serum-free solution of claim 9, wherein the serum-free solution is suitable as a release solution and comprises:
(a) greater than 90 percent by weight of the cell culture solution;
(b) greater than 0 up to about 2.0 percent by weight of an optional antibiotic-antimycotic solution;
(c) greater than 0 up to about 1.0 percent by weight of putrescine;
(d) greater than 0 up to about 1.0 percent by weight of 2-mercaptoethanol;
(e) greater than 0 up to about 20.0 percent by weight of albumin; and
(f) an optional amount of sterile sodium hydroxide or sterile hydrochloric acid to provide a serum-free solution having a pH of 7.4.

35. The serum-free solution of claim 34, wherein the serum-free solution comprises:
(a) 494.4 ml of the cell culture solution;
(b) 5.0 ml of an antibiotic-antimycotic solution comprising 10,000 units/ml Penicillin G, 10,000 μg/ml Streptomycin, and 25 μg/ml Amphotericin B;
(c) 0.05 mg of putrescine;
(d) 0.5 ml of a 55 mM 2-mercaptoethanol solution;
(e) 10.0 g of serum albumin; and
(f) an optional amount of sterile sodium hydroxide or sterile hydrochloric acid to provide a serum-free solution having a pH of 7.4.

36. The serum-free solution of claim 34, wherein the serum-free solution comprises:
(a) 499.4 ml of the cell culture solution;
(b) 0.05 mg of putrescine;
(c) 0.5 ml of a 55 mM 2-mercaptoethanol solution;
(d) 10.0 g of human serum albumin; and
(e) an optional amount of sterile sodium hydroxide or sterile hydrochloric acid to provide a serum-free solution having a pH of 7.4

37. A serum-free solution suitable for use as a release solution, said solution comprising:
(a) greater than 90 percent by weight of Dulbecco's phosphate buffered saline solution optionally containing calcium chloride and magnesium chloride;
(b) greater than 0 up to about 2.0 percent by weight of an optional antibiotic-antimycotic solution;
(c) greater than 0 up to about 1.0 percent by weight of putrescine;
(d) greater than 0 up to about 1.0 percent by weight of 2-mercaptoethanol; and
(e) an optional amount of sterile sodium hydroxide or sterile hydrochloric acid to provide a serum-free solution having a pH of 7.4.

38. The serum-free solution of claim 37, wherein the serum-free solution comprises:
(a) 494.4 ml of the buffered saline solution;
(b) 5.0 ml of an antibiotic-antimycotic solution comprising 10,000 units/ml Penicillin G, 10,000 μg/ml Streptomycin, and 25 μg/ml Amphotericin B;
(c) 0.05 mg of putrescine;
(d) 0.5 ml of a 55 mM 2-mercaptoethanol solution; and
(e) an optional amount of sterile sodium hydroxide or sterile hydrochloric acid to provide a serum-free solution having a pH of 7.4.

39. The serum-free solution of claim 37, wherein the serum-free solution comprises:
(a) 499.4 ml of the buffered saline solution;
(b) 0.05 mg of putrescine;
(c) 0.5 ml of a 55 mM 2-mercaptoethanol solution; and
(d) an optional amount of sterile sodium hydroxide or sterile hydrochloric acid to provide a serum-free solution having a pH of 7.4.

40. The serum-free solution of claim 37, wherein the serum-free solution comprises:
(a) greater than 90 percent by weight of Dulbecco's phosphate buffered saline solution without (i) calcium chloride and (ii) magnesium chloride;
(b) greater than 0 up to about 2.0 percent by weight of an optional antibiotic-antimycotic solution;
(c) greater than 0 up to about 1.0 percent by weight of putrescine;
(d) greater than 0 up to about 1.0 percent by weight of 2-mercaptoethanol; and
(e) greater than 0 up to 5.0 ml of a greater than 0 up to 1.0 M solution of ethylenediamine tetraacetic acid (EDTA); and
(f) an optional amount of sterile sodium hydroxide or sterile hydrochloric acid to provide a serum-free solution having a pH of 7.4.

41. The serum-free solution of claim 40, wherein the serum-free solution comprises:
(a) 492.3 ml of the phosphate buffered saline solution;
(b) 5.0 ml of an antibiotic-antimycotic solution comprising 10,000 units/ml Penicillin G, 10,000 μg/ml Streptomycin, and 25 μg/ml Amphotericin B;
(c) 0.05 mg of putrescine;
(d) 0.5 ml of a 55 mM 2-mercaptoethanol solution;
(e) 2.2 ml of a 0.5 M solution of EDTA; and
(f) an optional amount of sterile sodium hydroxide or sterile hydrochloric acid to provide a serum-free solution having a pH of 7.4.

42. The serum-free solution of claim 40, wherein the serum-free solution comprises:
(a) 497.3 ml of the phosphate buffered saline solution;
(b) 0.05 mg of putrescine;
(c) 0.5 ml of a 55 mM 2-mercaptoethanol solution;
(c) 2.2 ml of a 0.5 M solution of EDTA; and
(e) an optional amount of sterile sodium hydroxide or sterile hydrochloric acid to provide a serum-free solution having a pH of 7.4.

43. The serum-free solution of claim 40, wherein the serum-free solution further comprises:
(g) greater than 0 up to 100 mg trypsin.

44. The serum-free solution of claim 43, wherein the serum-free solution further comprises:
(a) 492.3 ml of the phosphate buffered saline solution;
(b) 5.0 ml of an antibiotic-antimycotic solution comprising 10,000 units/ml Penicillin G, 10,000 μg/ml Streptomycin, and 25 μg/ml Amphotericin B;
(c) 0.05 mg of putrescine;
(d) 0.5 ml of a 55 mM 2-mercaptoethanol solution;
(e) 2.2 ml of a 0.5M solution of EDTA;
(f) 50 mg trypsin; and
(g) an optional amount of sterile sodium hydroxide or sterile hydrochloric acid to provide a serum-free solution having a pH of 7.4.

45. The serum-free solution of claim 43, wherein the serum-free solution further comprises:
(a) 497.3 ml of the phosphate buffered saline solution;
(b) 0.05 mg of putrescine;
(c) 0.5 ml of a 55 mM 2-mercaptoethanol solution;
(d) 2.2 ml of a 0.5M solution of EDTA;
(e) 50 mg trypsin; and
(f) an optional amount of sterile sodium hydroxide or sterile hydrochloric acid to provide a serum-free solution having a pH of 7.4.
